(19) United States
(12) Patent Application Publication
(10) Pub. No.: US 2023/0413816 A1
(43) Pub. Date: Dec. 28, 2023

(54) COMPOSITIONS COMPRISING ALLYL SULFIDE AND A SURFACTANT AND METHODS OF USING SAME

(71) Applicant: The State of Israel, Ministry of Agriculture & Rural Development, Agricultural Research Organization, Rishon Lezion (IL)

(72) Inventor: Etti OR, Bat Hefer (IL)

(21) Appl. No.: 18/037,210

(22) PCT Filed: Nov. 18, 2021
(86) PCT No.: PCT/IL2021/051379

§ 371 Date: May 16, 2023

Related U.S. Application Data
(60) Provisional application No. 63/222,063, filed on Jul. 15, 2021.
(60) Provisional application No. 63/115,274, filed on Nov. 18, 2020.

(51) Int. Cl. A01N 41/12; A01N 25/30; A01P 21/00

(52) U.S. Cl. CPC A01N 41/12; A01N 25/30; A01P 21/00

(57) ABSTRACT

In one aspect of the invention, provided herein an agricultural composition comprising a synergistically effective amount of a sulfide compound and of a surfactant. Further, a method of using the composition of the invention such as for enhancing or inducing bud break in a plant, is provided.

### CROSS REFERENCE TO RELATED APPLICATIONS

This application claims the benefit of priority from U.S. Provisional Patent Application No. 63/222,063, filed Jul. 15, 2021, and from U.S. Provisional Patent Application No. 63/115,274, filed on Nov. 18, 2020, both entitled: COMPOSITIONS COMPRISING ALLYL SULFIDE AND A SURFACTANT AND METHODS OF USING SAME. The contents of the above applications are all incorporated herein by reference as if fully set forth herein in their entirety.

### FIELD OF THE INVENTION

This invention, in some embodiments thereof, relates to the field of bud breaking agents and methods for use thereof, such as for inducing bud break of a plant.

### BACKGROUND

Early marketing from vineyards grown in warm-winter regions is of high economical value. Unfortunately, vineyards in such regions often exhibits delayed and non-uniform bud break in early spring due to inadequate chilling. This represents a major obstacle for the commercial production of table grapes. Therefore, in warm winter regions, artificial induction of bud dormancy release, known also as bud break, is mandatory in order to coordinate a reliable production of economical grape yields.

The only effective artificial stimulus currently available for commercial use in vineyards is hydrogen cyanamide (HC). In warm- winter regions, initiation of bud break by application of HC to the dormant buds in the end of the winter is a critical management practice in commercial vineyards and is extensively utilized, primarily to advance extensive and a uniform bud break.

However, the ability of HC to induce respiratory stress, which initiates a biochemical cascade that leads to effective dormancy release, is also responsible for its toxicity, both to the vines and to the environment. Such phytotoxic effects may result in decreased bud break, irregular ripening and significant yield losses. According to current regulations, the use of HC in the deciduous tree industry is restricted in the EU. Therefore, there is an acute need for the development of safe and powerful alternatives for artificial induction of bud dormancy release.

Several studies have documented the potential use of garlic extracts and its volatiles as inducers of grape bud break. Initially, it was shown that brushing freshly ground garlic paste on the cut surface of cans from three grapevine cultivars enhanced bud break in comparison to the control. However, its enhancing effect was relatively mild and inferior even to the use of calcium cyanamide, which is known to be less effective than HC.

The bud break enhancing effect reported was generally achieved when garlic extract or its volatiles were either brushed on surface of single-node cuttings or incubated with the cuttings in sealed jars. However, it was also shown that the enhancing effect of an allyl sulfide (diallyl disulfide, abbreviated as DADS), one of active agents present in the garlic extract, when applied to the whole vine, rather than to cuttings, was very limited and inferior to HC. In the case of garlic paste, it was proved to be inferior to HC even when applied on cuttings. Thus, although garlic paste, DADS and similar products have shown to be more efficient than the control in initiating bud break, they all provide results highly inferior to those provided by HC under vineyard conditions.

Early marketing of table grapes is of high economical value. Therefore, enhanced bud break which precedes ripening is highly desirable. Thus, there is an unmet need to provide a formulation and an administration method for enhancing bud break to whole vines under field conditions.

The foregoing examples of the related art and limitations related therewith are intended to be illustrative and not exclusive. Other limitations of the related art will become apparent to those of skill in the art upon a reading of the specification.

### SUMMARY

The following embodiments and aspects thereof are described and illustrated in conjunction with systems, tools and methods which are meant to be exemplary and illustrative, not limiting in scope.

In one aspect of the invention, there is provided a composition comprising a sulfide compound and a surfactant; wherein (i) a weight per weight (w/w) ratio between the sulfide compound and the surfactant is between 20:1 and 1:2; (ii) the surfactant comprises an alkylated poly(ethylene glycol-co-propylene glycol) including any derivative thereof; and (iii) the sulfide compound comprises an alkyl sulfide, an alkenyl sulfide or both.

In one embodiment, the alkylated poly(ethylene glycol-co-propylene glycol) (PEG-PPG) comprises any one of a linear PEG-PPG, a branched PEG-PPG, or a star-shaped PEG-PPG.

In one embodiment, the alkylated poly(ethylene glycol-co-propylene glycol) is represented by Formula 1:

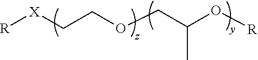

wherein:
each R independently comprises H or a C2-C30 alkyl; wherein X is selected from O, S, CH, CH2 or is absent; wherein y and z independently represents an integer being between 1 and 100; and wherein at least one R comprises the C2-C30 alkyl.

In one embodiment, the C2-C30 alkyl is a linear alkyl or a branched alkyl, optionally comprising (i) at least one unsaturated bond, (ii) at least one substituent, or both (i) and (ii).

In one embodiment, the branched alkyl comprises 2-ethyl-hexyl.

In one embodiment, the surfactant comprises 2-ethyl-hexyl poly(ethylene glycol-co-propylene glycol).

In one embodiment, the sulfide compound is represented by Formula 2: R₁—S—(X₁)ₐ—R₁, wherein each R₁ independently comprises H, a C1-C10 alkyl, or a C1-C10 alkenyl, and wherein at least one R₁ comprises C1-C10 alkyl or a C1-C10 alkenyl; wherein X₁ is S or is absent; and wherein a represents an integer between 1 and 5.

In one embodiment, the C1-C10 alkyl is a linear alkyl or a branched alkyl, optionally comprising (i) an unsaturated bond, (ii) a substituent, or both (i) and (ii).

In one embodiment, the sulfide compound is selected from the group consisting of C1-C10 dialkyl sulfide, C1-C10 dialkyl disulfide, C1-C10 dialkyl trisulfide, C1-C10 diallyl sulfide, C1-C10 diallyl disulfide, and C1-C10 diallyl trisulfide, or any combination thereof.

In one embodiment, the sulfide compound is selected from the group consisting of diethyl sulfide, diethyl disulfide, dimethyl sulfide, dimethyl trisulfide, dimethyl disulfide, including any derivative or any combination thereof; and wherein the alkenyl sulfide is selected from the group consisting of diallyl sulfide, diallyl disulfide (DADS), diallyl trisulfide, including any derivative or any combination thereof.

In one embodiment, the composition further comprises an agriculturally acceptable salt, optionally wherein a w/w concentration of the agriculturally acceptable salt within the composition is between 1 and 40%.

In one embodiment, the agriculturally acceptable salt is selected from the group consisting of a nitrate salt, a potassium salt, and a phosphate salt including any derivative or any combination thereof, and wherein the agriculturally acceptable salt optionally comprises a microelement selected from Mg, Ca, S, Fe, Mn, Zn, B, Cu, Mo and Si, including any derivative or any combination thereof.

In one embodiment, the composition further comprises an aqueous solvent, an organic water miscible solvent or both.

In another aspect, there is an agricultural composition comprising an agriculturally acceptable carrier and a synergistically effective amount of the sulfide compound and of the surfactant of the invention; wherein the synergistically effective amount comprises a w/w concentration of (i) the sulfide compound, and (ii) of the surfactant within the composition being at least 0.1%.

In one embodiment, the synergistically effective amount comprises a w/w concentration of (i) the sulfide compound, and (ii) of the surfactant within the composition being between 0.1 and 10%.

In one embodiment, the surfactant is represented by Formula 1.

In one embodiment, the sulfide compound is represented by Formula 2.

In one embodiment, the agricultural composition is formulated for administration by spraying or by irrigating.

In one embodiment, the synergistically effective amount is sufficient for inducing bud break in a plant.

In one embodiment, the plant is a perennial plant.

In another aspect, there is provided a kit comprising a first component comprising a sulfide compound and a second component comprising a surfactant; wherein the surfactant comprises an alkylated poly(ethylene glycol-co-propylene glycol) including any derivative thereof; and wherein the sulfide compound comprises an alkyl sulfide, an alkenyl sulfide, or both.

In one embodiment, the alkylated poly(ethylene glycol-co-propylene glycol) (PEG-PPG) comprises any one of a linear PEG-PPG, a branched PEG-PPG, or a star-shaped PEG-PPG, substituted with a C2-C30 alkyl, wherein the C2-C30 alkyl comprises a linear or branched alkyl optionally comprising (i) at least one unsaturated bond, (ii) at least one substituent, or both (i) and (ii).

In one embodiment, alkyl sulfide is selected from the group consisting of diethyl sulfide, diethyl disulfide, dimethyl sulfide, dimethyl trisulfide, dimethyl disulfide, including any derivative or any combination thereof; and wherein the alkenyl sulfide is selected from the group consisting of diallyl sulfide, diallyl disulfide (DADS), diallyl trisulfide, including any derivative or any combination thereof.

In one embodiment, the kit comprises instructions for mixing the first component and the second component, so as to obtain a mixture wherein a w/w ratio between the sulfide compound and the surfactant within the mixture is between 5:1 and 1:1.

In one embodiment, a w/w concentration of (i) the sulfide compound, and (ii) of the surfactant within the mixture is between 0.1 and 10%.

In another aspect, there is a method for inducing bud break in a plant, comprising contacting the plant with the agricultural composition of the invention, or with the kit any of the invention.

In one embodiment, the plant is a perennial plant.

In one embodiment, contacting comprises administering the composition or the kit to plant bulbs, plant tubers, plant roots, plant branches, plant trunk or any combination thereof.

In one embodiment, administering is by irrigation, spraying, coating, brushing, or any combination thereof.

In one embodiment, a w/w concentration of the sulfide compound within the composition is between 0.1 and 10%.

In one embodiment, a w/w concentration of the surfactant within the composition is between 0.01 and 10%.

In addition to the exemplary aspects and embodiments described above, further aspects and embodiments will become apparent by study of the following detailed description.

### BRIEF DESCRIPTION OF DRAWINGS

FIG. 1 is a graph presenting a comparison between the bud break efficiency of the exemplary compositions of the invention and controls, when applied to spur-pruned cv. Early Sweet vines at the beginning of January in a vineyard located at Argaman, the Jordan Valley, Israel. Bud counts were conducted once a week and started about 4 weeks after treatment. The tested combinations were as follows: (a) DADS at 6% w/w, together with (b) 2% w/w of a non-ionic surfactant (abbreviated as T3-D2, T4-D2, T5-D2, T6-D2 or T7-D2, respectively) or of a cationic surfactant (Armobreak®, abbreviated as T1-D2). The controls were as follows: (a) plants treated with Triton X-100 (abbreviated as Con), and (b) single treatments with DADS, HC, and the surfactants (abbreviated as T1, T3, T4, T5, T6 or T7, respectively). The chemical structures of the surfactants are as represented in Table 1, below. The Y-axis represents the percentage of the bursting buds out of the total number of the buds on a vine.

FIG. 2 is an illustration showing an exemplary location of basal, central and distal buds on a spur. Basal bud are often characterized by poor bursting ability (represented by the brown color) due to establishment of apical dominance upon activation of the distal bud.

FIG. 3 is bar graph presenting a comparison of the efficiency of the three superior treatments presented in FIG. 1 (HC, T1-D2 and T7-D2) in induction of bud break of buds in basal position. The Y-axis represent the percentage of bursting basal buds out of total number of spurs on a vine.

FIG. 4 is a bar graph presenting a comparison between the bud break efficiency of the exemplary compositions of the invention containing DADS (about 6% w/w) and T7 (2% w/w), versus HC when applied to whole cane- pruned cv. Scarlota vineyard (located at Lachish, Israel). The Y-axis represents the percentage of the bursting buds out of the total number of the buds on all canes on a vine, as scored 28 days (4 Apr) and 35 days (11 Apr) after treatment.

FIGS. 5A-5B are bar graphs presenting a comparison between the bud break efficiency of the exemplary compositions of the invention and controls in vine. The X-axis represents different treatments, and the Y-axis represents vine growth stage according to the BBCH scale, as scored 36 days after treatment. FIG. 5A represents a comparison between the synergistic bud break efficiency of T7 in combination with different sulfide compounds (DADS and dimethyl sulfide, DMS). 1—untreated vines (negative control); 2—2.5% w/w DMS and 2% w/w T7; 3—5% w/w DMS and 2% w/w T7; 4—HC (positive control); 5—5% w/w DADS and 2% w/w T7. FIG. 5B represents a comparison between the synergistic bud break efficiency of 6% w/w DADS in combination with various concentrations of T7 (entries 4-7) versus controls (entries 1-2, and 8). 1—untreated vines (negative control); 2—12% w/w T7 no DADS; 3—6% w/w DADS no T7; 4—6% w/w DADS and 12% w/w T7; 5—6% w/w DADS and 1% w/w T7; 6—6% w/w DADS and 2% w/w T7; 7—6% w/w DADS and 0.5% w/w T7; 8—HC (positive control).

### DETAILED DESCRIPTION

The present invention is directed to a composition comprising a sulfide compound and a surfactant; wherein (i) a weight per weight (w/w) ratio between the sulfide compound and the surfactant is between 10:1 and 1:2, or between 20:1 and 1:20; (ii) the surfactant comprises a poly(ethylene glycol-co-propylene glycol) including any derivative thereof, and (iii) the surfactant is substantially devoid of an alkyl amine surfactant.

The present invention is also directed to a method enhancing or inducing bud break in a plant, comprising contacting a composition or a kit described herein with the plant, thereby enhancing or inducing bud break within the plant.

The present invention is based, in part, on the finding that compositions comprising a non-ionic surfactant (e.g. a poly(ethylene glycol-co-propylene glycol), PEG-PPG based surfactant) and an allyl sulfide (such as diallyl disulfide, abbreviated as DADS) exhibited an improved bud break efficiency compared to a single administration of the allyl sulfide or of the non-ionic surfactant. Furthermore, some of the compositions disclosed herein exhibit a synergistic effect with respect to the bud break induction within a plant, upon applying of a composition of the invention to the plant. Surprisingly, other poly(ethylene glycol) (PEG) based non-anionic surfactants (such as PEG 1110 mono(hexadecyl/octadecyl)ether; and C9-11 pareth-3) did not show any significant synergistic effect, when applied together with a sulfide compound (DADS).

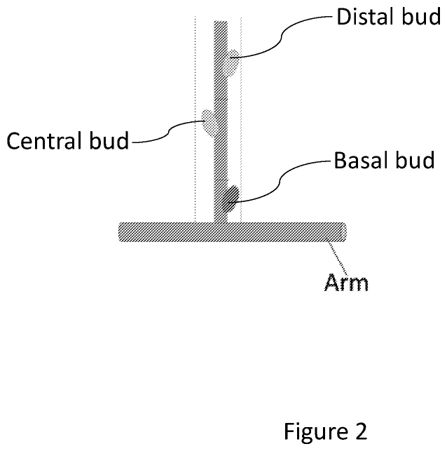

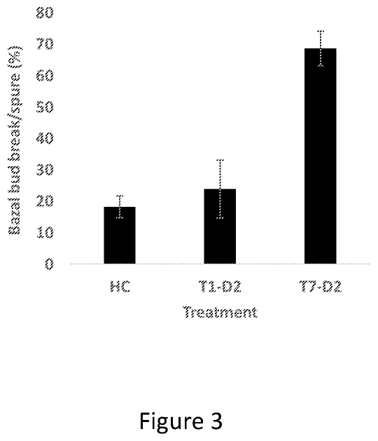

In particular, the present invention is based, in part, on the finding that a composition comprising the surfactant of the invention (such as poly(ethylene glycol-co-propylene glycol)-mono(2-ethylhexyl)ether) and a sulfide compound (DADS) exhibits substantial enhancement of the bud breaking efficiency as compared to commercially available reagent (HC), and as confirmed by numerous field experiments. Specifically, a surfactant of the invention having PEG-PPG chain substituted with a branched alkyl (such as 2-ethylhexyl) showed superior efficiency over the commercially available bud-breaking agents (such as HC) and over other PEG based surfactants, including inter alia Armobreak® (T1). Moreover, exemplary compositions or kits of the invention showed superiority over the commercially available bud-breaking agents (e.g. HC and Armobreak®), with respect to the uniformity of the dormancy release of buds across the spur/cane as illustrated in FIG. 2. For example, treatment with T7 and DADS resulted in enhanced bud break of basal buds under spur pruning regime (see FIG. 3) and of central buds under cane-pruning regime. Additionally, the tested compositions did not show any detectable harmful effect to the plant.

Thus, the present invention provides a composition or a kit for use in induction and/or enhancement bud break in a plant. Specifically, application of the compositions and/or kits disclosed herein results in a uniform bud break.

### The Composition

According to one aspect, there is provided a composition comprising a sulfide compound, and a non-ionic surfactant comprising a poly(ethylene glycol-co-propylene glycol) including any derivative thereof.

In some embodiments, the surfactant comprises is a polymeric non-ionic surfactant. In some embodiments, the surfactant comprises a polymeric surfactant, wherein the polymer comprises a plurality of repeating units, wherein the repeating units are alkyl-ether units. In some embodiments, the surfactant is a polymeric surfactant comprising a plurality of alkyl-ether repeating units.

In some embodiments, the surfactant of the invention consists essentially of a non-ionic surfactant, such as a non-ionic polymeric surfactant. In some embodiments, the surfactant of the invention consists essentially of a non-ionic polymer, wherein consists essentially of is as described herein.

The term “non-ionic” is well-understood by a skilled artisan, as being referred to compound (e.g., an uncharged molecule, or a neutral polymer) being substantially devoid of a negative and/or positive charge. One skilled in the art will appreciate, that the terms “non-ionic” and “uncharged” are used herein interchangeably and may refer inter alia to a solution of the surfactant at a pH of between 2 and 9, between 3 and 8, between 4 and 8, between 5 and 8, between 6 and 8, including any range therebetween.

In some embodiments, the surfactant is or comprises a polymer. In some embodiments, the surfactant is or comprises a polymeric surfactant. In some embodiments, the surfactant is or comprises a polymer, wherein the polymer comprises a plurality of alkoxy repeating units, and wherein the polymer is neutral in an aqueous solution at a pH of between 5 and 8 including any range therebetween.

In some embodiments, the surfactant or the composition of the invention is substantially devoid of amine groups. In some embodiments, the surfactant or the composition of the invention is substantially devoid of an alkoxylated alkylamine. In some embodiments, the surfactant or the composition of the invention is substantially devoid of an alkoxylated secondary alkylamine. In some embodiments, the surfactant or the composition of the invention is substantially devoid of an alkoxylated tertiary alkylamine. In some embodiments the surfactant or the polymer comprises a backbone and/or a side chain being substantially devoid of amine groups. In some embodiments, the backbone and/or a side chain of the polymeric surfactant is substantially devoid of a (positive or negative) charge. In some embodiments, the backbone and/or a side chain of the polymeric surfactant is substantially devoid of a (positive or negative) charge, when applied to an aqueous solvent at a pH of between 2 and 9, including any range between. In some embodiments, the backbone and/or a side chain of the polymeric surfactant is substantially devoid of a charged group. In some embodiments, the backbone and/or a side chain of the polymeric surfactant is substantially devoid of an amine group. In some embodiments, the polymeric surfactant of the invention is substantially devoid of N, N-Bis-2-(omega-hydroxy polyoxyethylene/polyoxypropylen)ethylalkylamine).

In some embodiments, the term “substantially devoid” refers to an amount of the specific compound within the surfactant, the kit and/or the composition of the invention being not more than trace amount (e.g., a w/w concentration less than 0.05%, less than less than 0.005%, less than 0.001%, etc., including any range between). In some embodiments, the term “substantially devoid” refers to an amount of the specific compound within the surfactant, the kit and/or the composition of the invention being less than the effective amount required for inducing or enhancing any biological effect (e.g. synergistic bud-breaking effect with a plant) mentioned herein.

In some embodiments, the surfactant of the invention (e.g., a backbone of the polymeric surfactant) comprises a plurality of alkoxy repeating units, wherein the alkoxy repeating unit comprises a linear alkyl and/or a branched alkyl substituted or non-substituted. In some embodiments, the alkoxy repeating unit comprises an optionally substituted alkyl having between 1 and 10, between 1 and 3, between 1 and 2, between 2 and 4, between 4 and 6, between 6 and 8, between 8 and 10 carbon atoms including any range therebetween. In some embodiments, the alkyl comprises ethyl, propyl, isopropyl, and/or a combination thereof. In some embodiments, the polyalkoxy backbone comprises a plurality of repeating units, wherein each of the repeating units comprises any of ethyl oxide, propyl oxide, isopropyl oxide or a combination thereof.

In some embodiments, the surfactant of the invention comprises a plurality of ethylene oxide repeating units (e.g., PEG) and/or a plurality of propylene oxide (e.g., polypropyleneoxide (PPG)) repeating units. In some embodiments, the surfactant of the invention comprises a co-polymer (e.g., random copolymer, block co-polymer, graft co-polymer), wherein the co-polymer comprises at least two different repeating units. In some embodiments, the surfactant of the invention comprises a block co-polymer, wherein the block co-polymer comprises at least two polymeric blocks bound via a covalent bond. In some embodiments, the polymeric blocks are the same or different. In some embodiments, each of the polymeric blocks of the surfactant of the invention comprises a polyalkyl-ether (e.g., comprising a plurality of alkoxy repeating units). In some embodiments, each of the polymeric blocks of the surfactant of the invention comprises PEG and/or PPG.

In some embodiments, the surfactant of the invention comprises PEG-PPG copolymer, wherein the copolymer is a random copolymer, or a block copolymer.

In some embodiments, the surfactant of the invention comprises an alkylated poly(ethylene glycol-co-propylene glycol) (PEG-PPG). In some embodiments, the alkylated PEG-PPG is represented by Formula 1:

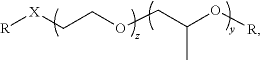

wherein:
each R independently comprises H or a C2-C30 alkyl; wherein X is selected from O, S, CH, CH2 or is absent; wherein z and y independently represent an integer between 1 and 100; and wherein at least one R comprises C2-C30 alkyl. In some embodiments, z and y represent an integer wherein the integers are the same or different. In some embodiments, at least one R comprises at least 2, at least 4, at least 5, at least 6, at least 8 carbon atoms, including any range between.

Without being bound to any specific theory or mechanism, it is postulated, that the surfactant of the invention represented by Formula 1, wherein at least one R comprises at least 4, at least 5, at least 6, at least 8 carbon atoms, is characterized by a superior synergistic efficiency (e.g. bud breaking effect, when applied to the plant together with the sulfide compound), compared to a similar surfactant with at least one R having less than 4 carbon atoms. Additionally, without being bound to any specific theory or mechanism it is postulated, that when R is a branched alkyl, the surfactant is characterized by a superior synergistic activity, compared to a similar surfactant with R being a linear alkyl.

In some embodiments, the surfactant of the invention comprises a plurality of ethylene oxide repeating units (EO) and a plurality of propylene oxide repeating units (PO). In some embodiments, a number of the EO (e.g. integer z) or a number of the PO (e.g. integer y) within the surfactant of the invention is independently between 2 and 100, between 2 and 4, between 4 and 6, between 6 and 9, between 9 and 15, between 15 and 20, between 20 and 30, between 30 and 40, between 40 and 50, between 50 and 100, including nay range between.

In some embodiments, a ratio between a number of PO (e.g. integer y) and a number of EO (e.g. integer z) within the surfactant of the invention is between 5:1 and 1:5, between 10:1 and 1:10, between 10:1 and 5:1, between 5:1 and 3:1, between 3:1 and 2:1, between 2:1 and 1:1, between 1:1 and 1:2, between 1:2 and 1:3, between 1:3 and 1:5, between 1:5 and 1:10, including any range between.

In some embodiments, the C2-C30 alkyl is a linear alkyl or a branched alkyl, optionally comprising (i) at least one (e.g. 1, 2, or 3, etc.) unsaturated bond, (ii) at least one (e.g. 1, 2, or 3, etc.) substituent, or both (i) and (ii), wherein the substituent is as described herein. In some embodiments, the C2-C30 alkyl comprises a C2-C10 alkyl, a C2-C5 alkyl, a C5-C10 alkyl, a C10-C15 alkyl, a C15-C18 alkyl, a C18-C20 alkyl, a C20-C25 alkyl, a C25-C30 alkyl, including any range between.

In some embodiments, the C2-C30 alkyl is or comprises branched alkyl. In some embodiments, the branched alkyl is or comprises a C2-C10 branched alkyl, a C2-C5 branched alkyl, a C5-C10 branched alkyl, a C10-C15 branched alkyl, a C15-C18 branched alkyl, a C18-C20 branched alkyl, a C20-C25 branched alkyl, a C25-C30 branched alkyl, including any range between. In some embodiments, the branched alkyl comprises 2-ethyl-hexyl.

In some embodiments, the surfactant of the invention is or comprises 2-ethyl-hexyl poly(ethylene glycol-co-propylene glycol).

In some embodiments, the surfactant of the invention comprises a linear block co-polymer. In some embodiments, the surfactant of the invention comprises a branched block co-polymer. In some embodiments, the surfactant of the invention comprises a graft co-polymer. In some embodiments, the graft co-polymer comprises a backbone and a plurality of co-polymers (e.g., block-co-polymers).

In some embodiments, the polymer composing the surfactant of the invention comprises a terminating segment. In some embodiments, the polymer (e.g., a branched polymer) comprises a plurality of terminating segments. One skilled in the art will appreciate, that a polymeric chain (e.g., formed by a ring opening polymerization) comprises a reactive group at the end of the polymeric chain (also used herein as terminating segment). The terminating segment refers to a “living” (e.g., reactive) end group of the propagating chain during the polymerization process. The terminating segment should be distinguished from the starting segment, usually comprising an initiator of the polymerization reaction.

In some embodiments, at least one terminating segment of the polymeric chain of the surfactant of the invention comprises a hydroxyl group. In some embodiments, at least one terminating segment of the polymeric chain of the surfactant of the invention comprises a hydroxyalkyl group. In some embodiments, at least one terminating segment of the polymeric chain of the surfactant of the invention comprises an ether group. In some embodiments, at least one terminating segment of the polymeric chain of the surfactant of the invention comprises alkylated hydroxyl. In some embodiments, the polymer of the invention is substantially devoid of a hydroxy group.

In some embodiments, the surfactant of the invention comprises poly(ethylene glycol-co-propylene glycol) (PEG-co-PPG). In some embodiments, the surfactant of the invention consists essentially of PEG-co-PPG and/or a derivative thereof. In some embodiments, the PEG-co-PPG is linear or branched. In some embodiments, the PEG-co-PPG is a random copolymer, a block co-polymer, a graft co-polymer or a combination thereof.

In some embodiments, the surfactant of the invention comprises an alkylated PEG-co-PPG. In some embodiments, the alkylated PEG-co-PPG comprises an alkyl group (e.g., alkyl ether) and/or an aryl group (e.g., aryl ether) as the terminating segment. In some embodiments, the alkyl group and/or an aryl group is bound to a hydroxy group (e.g., a terminal hydroxy group) of the polymer. In some embodiments, the alkyl group and/or an aryl group is bound to a hydroxy group (e.g., a terminal hydroxy group) of the PEG-co-PPG based polymer, so as to form an alkyl ether as the terminating segment. In some embodiments, the alkyl group is a linear or a branched alkyl comprising between 1 and 20, between 1 and 5, between 5 and 10, between 10 and 15, between 15 and 20, carbon atoms including any range therebetween. In some embodiments, the alkylated PEG-co-PPG comprises a monoalkyl ether or a plurality of alkyl ethers. In some embodiments, the alkylated PEG-co-PPG comprises an aryl ether and/or an alkyl ether.

In some embodiments, the terminating segment of the alkylated PEG-co-PPG comprises an alkyl ether as the terminating segment, wherein the alkyl ether comprises a C1-C20 alkyl, as described hereinabove. In some embodiments, the terminating segment of the alkylated PEG-co-PPG comprises an alkyl ether as the terminating segment, wherein the alkyl ether comprises 2-ethylhexyl ether, methyl ether, ethyl ether, butyl ether, propyl ether, isopropyl ether, pentyl ether, hexyl ether, octyl ether, decyl ether, dodecyl ether, lauryl ether including any alkylated and/or hydroxylated derivatives thereof and/or any combination thereof.

In some embodiments, the alkylated PEG-co-PPG is selected from 2-ethylhexyl, methyl, ethyl, butyl, propyl, isopropyl, pentyl, hexyl, octyl, decyl, dodecyl, lauryl PEG-co-PPG monoalkyl ether, including any alkylated and/or hydroxylated derivatives thereof and/or any combination thereof.

In some embodiments, the surfactant of the invention consists essentially of an alkylated PEG-co-PPG (e.g. poly(ethylene glycol-co-propylene glycol)-mono(2-ethylhexyl)ether.

In some embodiments, the surfactant of the invention comprises a derivative of the alkyl-ether polymer. In some embodiments, the surfactant of the invention comprises a PEG-co-PPG derivative. In some embodiments, the poly(alkyl-ether) derivative (e.g., PEG-co-PPG derivative) comprises a terminating segment and/or the starting segment having any of an ester, a carboxy, an amide, an anhydride, a substituted alkyl or a combination thereof. Other derivatives having additional functional groups as the terminating and/or starting segment are well-known in the art. In some embodiments, the poly(alkyl-ether) is modified after completion of the chain polymerization, so as to obtain a derivative thereof. In some embodiments, the poly(alkyl-ether) is modified at the chain termination step.

In some embodiments, the surfactant of the invention comprises an agriculturally acceptable polymer.

In some embodiments, the polymeric surfactant of the invention is characterized by a molecular weight (MW) of between 100 and 10.000 Da, between 100 and 300 Da, between 300 and 500 Da, between 500 and 1.000 Da, between 1000 and 2.000 Da, between 2000 and 5.000 Da, between 5.000 and 10.000 Da, including any range therebetween.

As used herein, the term MW refers to the weight average molecular weight of the polymer. As used herein, the term “weight average molecular weight” generally refers to a molecular weight measurement that depends on the contributions of polymer molecules according to their sizes.

In some embodiments, the aqueous solubility of the surfactant is at least 0.1 g/L, at least 0.5 g/L, at least 1 g/L, at least 5 g/L, at least 10 g/L, at least 50 g/L, at least 100g/L, including any range therebetween.

In some embodiments, the surfactant of the invention is characterized by HLB (hydrophobic lipophilic balance) of between 10 and 20, between 10 and 15, between 12 and between 15 and 20, including any range therebetween.

In some embodiments, the composition of the invention comprises the surfactant as described hereinabove and a sulfide compound. In some embodiments, the sulfide compound is substantially non-water soluble. In some embodiments, the aqueous solubility of the sulfide compound is at most 1 g/L, at most 0.5 g/L, at most 0.1 g/L, at most 0.01 g/L, at most 0.001 g/L, including any range therebetween. In some embodiments, the sulfide compound of the invention is a natural or a synthetic compound. In some embodiments, the sulfide compound of the invention is derived from a plant. In some embodiments, the sulfide compound of the invention is extracted from a plant. In some embodiments, the sulfide compound of the invention is in a form of a plant extract (e.g., garlic extract). In some embodiments, the sulfide compound of the invention is in a form of a plant extract enriched with one or more sulfide compound.

In some embodiments, the sulfide compound of the invention is represented by Formula 2: R₁—S—(X₁)ₐ—R₁, wherein each R₁ independently comprises H, a C1-C10 alkyl, or a C1-C10 alkenyl; and wherein at least one R₁ comprises C1-C10 alkyl or a C1-C10 alkenyl; wherein X₁ is S or is absent; and wherein a represents an integer between 1 and 5, between 1 and 3, between 2 and 4, between 3 and 5 including any range between. In some embodiments, a is any of 1, 2, 3, or 4. In some embodiments, each Ri represents the same or different alkyl.

In some embodiments, the C1-C10 alkyl or alkenyl is a linear or a branched alkyl, optionally comprising (i) at least one (e.g. 1, 2, or 3, etc.) unsaturated bond, (ii) at least one (e.g. 1, 2, or 3, etc.) substituent, or both (i) and (ii). In some embodiments, the substituent is as described herein. In some embodiments, the C1-C10 alkyl or alkenyl is or comprises C1-C10 alkyl, a C 1 -C3 alkyl, a C3-C5 alkyl, a C5-C10 alkyl or alkenyl, respectively, including any range between.

In some embodiments, the sulfide compound of the invention is represented by Formula 3: R₁—S—S—R₁, or by Formula 4: R₁—S—R₁, wherein R₁ is as described herein.

In some embodiments, the sulfide compound of the invention comprises at least one alkyl sulfide, at least one alkenyl sulfide, at least one alkynyl sulfide, or any combination thereof. In some embodiments, the sulfide compound of the invention comprises a mono alkenylsulfide and/or a dialkenyl sulfide. In some embodiments, the sulfide compound of the invention comprises a mono alkylsulfide and/or a dialkyl sulfide. In some embodiments, the alkyl sulfide comprises at least one alkyl group, selected from a branched or a linear alkyl comprising between 1 and 10, between 1 and 3, between 3 and 5, between 5 and 7, between 7 and 10 carbon atoms including any range therebetween. In some embodiments, the alkyl sulfide of the invention comprises one or more alkyl groups, wherein each of the alkyl groups is independently selected from an alkane, alkene, and alkyne, or a combination thereof, wherein each of the alkyl groups is independently selected from a linear and branched alkyl.

In some embodiments, the alkenyl sulfide comprises at least one alkenyl group, selected from a branched or a linear alkenyl comprising between 1 and 10, between 1 and 3, between 3 and 5, between 5 and 7, between 7 and 10 carbon atoms including any range therebetween, and further comprises 1, 2, 3, 4, or 5 unsaturated bonds (e.g. carbon-carbon double bond). In some embodiments, the at least one alkenyl groups comprises an allyl group. In some embodiments, the one or more alkyl groups or alkenyl groups comprises a C1-C5, C1-C4, C1-C3, C2-C5, C2-C4 alkane group or alkene group, respectively, including any range therebetween.

In some embodiments, the sulfide compound comprises a plurality of sulfur atoms, wherein the plurality of sulfur atoms are covalently bound to each other via a disulfide bond. In some embodiments, the sulfide compound comprises a mono-sulfide, a disulfide, a trisulfide, a tetrasulfide moiety or any combination thereof. Other polysulfide moieties are well-known in the art.

In some embodiments, the composition of the invention comprises a plurality of sulfide compounds.

In some embodiments, the sulfide compound of the invention is selected from mercaptoalkyl, mercaptoallyl, a dialkylsulfide, dialkyldisulfide, dialkyltrisulfide, diallyl sulfide, diallyl disulfide (DADS), diallyl trisulfide, diethyl sulfide, diethyl disulfide, dimethyl sulfide, dimethyl trisulfide, dimethyl disulfide, triallyl disulfide, sulfur compounds containing allyl, methyl, n-butyl, n-propyl, thiosulfate, thiosulfonate, allicin, allyl isothiocyanate, alkyl isothiocyanate, S-methyl cysteine sulfoxide, cysteine, glutathione, dimethyl thiosulfonate, including any derivative or any combination thereof.

According to some embodiments of the invention, one or more sulfide compound of the invention is naturally found in garlic, Chinese chives and/or Rakkyo, thus, formulations containing garlic, Chinese chives and/or Rakkyo may also be administered as the sulfide compound.

In some embodiments, the surfactant of the invention prolongs stability of the sulfide compound within the composition of the invention. In some embodiments, the surfactant of the invention increases the half-life of the sulfide compound of the invention. In some embodiments, the surfactant of the invention prolongs the stability of the sulfide compound of the invention by at least 20%, at least 30%, at least 40%, at least 50%, at least 60%, at least 70%, at least 80%, at least 90%, at least 100%, at least 200%, at least 300%, at least 500%, at least 700%, at least 1000%, compared to the stability of the pristine sulfide compound (e.g., devoid of the surfactant) including any value therebetween.

In some embodiments, the surfactant of the invention enhances biological efficacy of the sulfide compound of the invention by at least 20%, at least 30%, at least 40%, at least 50%, at least 60%, at least 70%, at least 80%, at least 90%, at least 100%, at least 200%, at least 300%, at least 500%, at least 700%, at least 1000%, compared to the efficacy (e.g., with respect to bud break induction) of the pristine sulfide compound (e.g., devoid of the surfactant) including any value therebetween.

In some embodiments, the surfactant of the invention enhances biological uptake of the sulfide compound of the invention by at least 20%, at least 30%, at least 40%, at least 50%, at least 60%, at least 70%, at least 80%, at least 90%, at least 100%, at least 200%, at least 300%, at least 500%, at least 700%, at least 1000%, compared to the uptake (e.g., by a plant) of the pristine sulfide compound (e.g., devoid of the surfactant) including any value therebetween.

In some embodiments, the surfactant of the invention enhances aqueous solubility of the sulfide compound of the invention by at least 20%, at least 30%, at least 40%, at least 50%, at least 60%, at least 70%, at least 80%, at least 90%, at least 100%, at least 200%, at least 300%, at least 500%, at least 700%, at least 1000%, at least 10.000%, at least 100.000%, at least 1.000.000%, compared to the aqueous solubility of the pristine sulfide compound (e.g. devoid of the surfactant) including any value therebetween.

In some embodiments, the surfactant of the invention substantially prevents or reduces decomposition or degradation of the sulfide compound (such as due to oxidation of the sulfide). In some embodiments, the surfactant of the invention substantially prevents or reduces oxidation of the sulfide compound.

In some embodiments, the composition of the invention consists essentially of the surfactant of the invention and the sulfide compound of the invention, also referred to herein as “the active ingredients”. In some embodiments, at least 80%, at least 90%, at least 93%, at least 95%, at least 97%, at least 99%, at least 99.5%, at least 99.9%, including any range between, by dry weight (e.g. devoid of a solvent) of the composition of the invention consists of the surfactant of the invention and of the sulfide compound of the invention.

In some embodiments, the composition of the invention comprises the surfactant of the invention and the sulfide compound of the invention, wherein a w/w ratio between the sulfide compound and the surfactant within the composition is between 20:1 and 1:20, between 20:1 and 15:1, between 15:1 and 1:1, between 15:1 and 13:1, between 13:1 and 12:1, between 12:1 and 10:1, between 10:1 and 1:1, between 10:1 and 8:1, between 8:1 and 5:1, between 5:1 and 1:1, between 5:1 and 4:1, between 4:1 and 3:1, between 3:1 and 2:1, between 2:1 and 1:1, between 1:1 and 1:20, between 1:1 and 1:15, between 1:1 and 1:2, between 1:2 and 1:7, between 1:7 and 1:10, between 1:10 and 1:15, between 1:15 and 1:20, including any value therebetween.

In some embodiments, a w/w ratio between the sulfide compound and the surfactant within the composition of the invention is between 10:1 and 5:1, between 10:1 and 8:1, between 8:1 and 6:1, between 6:1 and 5:1, between 5:1 and 3:1, between 3:1 and 1:1, including any value therebetween.

In some embodiments, a w/w ratio between the sulfide compound and the surfactant within the composition of the invention is between 1:10 and 1:1, between 1:10 and 1:9, between 1:9 and 1:7, between 1:7 and 1:5, between 1:5 and 1:4, between 1:4 and 1:3, between 1:3 and 1:2, between 1:2 and 1:1, including any value therebetween.

In some embodiments, a molar ratio of the sulfide compound to the surfactant within the composition is between 50:1 and 1:50, between 50:1 and 1:1, between 50:1 and 40:1, between 40:1 and 30:1, between 30:1 and 25:1, between 25:1 and 20:1, between 20:1 and 15:1, between 15:1 and 10:1, between 10:1 and 5:1, between 5:1 and 1:1, between 2:1 and 1:1, between 1:1 and 1:2, between 1:2 and 1:7, between 1:7 and 1:10, between 1:10 and 1:15, between 1:15 and 1:20, between 1:20 and 1:25, between 1:25 and 1:30, between 1:30 and 1:40, between 1:40 and 1:50, including any range or value therebetween. In some embodiments, a molar ratio of the sulfide compound to the surfactant within the composition is between 50:1 and 1:1, including any range or value therebetween.

In some embodiments, the composition of the invention is an agricultural composition. In some embodiments, the composition of the invention is an aqueous formulation (also used herein as “formulation”). In some embodiments, the aqueous composition of the invention is an emulsion. In some embodiments, the aqueous composition of the invention is a micro-emulsion. In some embodiments, the micro-emulsion comprises micro sized micelles having an average particle size between 1 and 500 um, between 1 and 10 um, between 10 and 50 um, between 50 and 100 um, between 100 and 500 um, including any range between. In some embodiments, the average particle size refers to a number average or to a geometric mean (these terms are well known in the art). In some embodiments, the composition is a dispersion. In some embodiments, the composition of the invention is a suspension.

In some embodiments, the composition of the invention is substantially homogeneous. In some embodiments, the composition is substantially inhomogeneous. In some embodiments, the composition comprises one or more liquid phases.

The disclosed compositions set forth above may be formulated in any manner. Non-limiting formulation examples include but are not limited to Dried grains, Emulsifiable concentrates (EC), Wettable powders (WP), Soluble liquids (SL), Aerosols, Ultra-low volume concentrate solutions (ULV), Soluble powders (SP), Microencapsulation, Water dispersed granules (WDG), Flowables (FL), Microemulsions (ME), Nano-emulsions (NE), etc. In any formulation described herein, percent of the active ingredient is well within the skills of the artisan e.g., within a range of 0.01% to 99.99%. In some embodiments, the active ingredient of the composition includes the sulfide compound and/or the surfactant of the invention.

In some embodiments, a w/w concentration of the sulfide compound of the invention within the composition of the invention is from 0.1% to 90%, from 0.1% to 0.5%, from 0.5% to 1%, from 0.1% to 0.3%, from 0.3% to 0.5%, from 0.5% to 0.7%, from 0.7% to 1%, from 1% to 1.5%, from 1.5% to 2%, from 2% to 2.5%, from 2.5% to 3%, from 3% to 3.5%, from 3.5% to 4%, from 4% to 5%, from 5% to 6%, from 6% to 7%, from 7% to 8%, from 8% to 10%, from 10% to 20%, from 20% to 30%, from 30% to 40%, from 40% to 50%, from 50% to 60%, from 60% to 70%, from 70% to 80%, from 80% to 90%, including any range or value therebetween.

In some embodiments, a w/w concentration of the surfactant of the invention within the composition of the invention is from 0.01% to 50%, from 0.01% to 0.1%, from 0.1% to 0.5%, from 0.5% to 1%, from 0.1% to 0.3%, from 0.3% to 0.5%, from 0.5% to 0.7%, from 0.7% to 1%, from 1% to 1.5%, from 1.5% to 2%, from 2% to 2.5%, from 2.5% to 3%, from 3% to 3.5%, from 3.5% to 4%, from 4% to 5%, from 5% to 6%, from 6% to 7%, from 7% to 8%, from 8% to 10%, from 10% to 20%, from 20% to 30%, from 30% to 40%, from 40% to 50%, including any range or value therebetween.

In some embodiments, the composition of the invention is an EC (emulsifiable concentrate). In some embodiments, w/w concentration of the sulfide compound within the composition of the invention (e.g., EC) is from 10% to 20%, from 20% to 30%, from 30% to 40%, from 40% to 50%, from 50% to 60%, from 60% to 70%, from 70% to 80%, from 80% to 90%, including any range or value therebetween, wherein the sulfide compound comprises one or more alkyl sulfides and/or alkenyl sulfides of the invention.

In some embodiments, w/w concentration of the surfactant within the composition of the invention (e.g., EC) is from 5% to 50%, from 5% to 10%, from 10% to 20%, from 1% to 5%, from 20% to 30%, from 30% to 40%, from 40% to 50%, including any range or value therebetween.

In some embodiments, the composition of the invention further comprises an agriculturally acceptable salt (e.g. as an additive). In some embodiments, the agriculturally acceptable salt is selected from the group consisting of a nitrate salt, a potassium salt, and a phosphate salt including any derivative or any combination thereof.

Non-limiting of agriculturally acceptable salts (e.g, cations) include but are not limited to alkali metal and/or earth alkali metal cations, which are well-known in the art.

In some embodiments, the agriculturally acceptable salt is a plant nutrient. In some embodiments, the plant nutrient is selected from, but is not limited to nitrogen based anions (such as an agriculturally acceptable nitrate or nitrite salt), phosphorus based anions (such as an agriculturally acceptable phosphate salt), an agriculturally acceptable potassium salt, a metal salt (such as an agriculturally acceptable Mg(II)-, Zn(II)-, and Mn(II) salt) or any combination thereof.

In some embodiments, the plant nutrient comprises a micro element selected from Mg, Ca, S, Fe, Mn, Zn, B, Cu, Mo and Si, including any derivative (such as cations or salts thereof) or any combination thereof.

In some embodiments, the composition of the invention consists essentially of the surfactant of the invention, of the sulfide compound of the invention and of the agriculturally acceptable salt, as described herein.

In some embodiments, a w/w concentration of the agriculturally acceptable salt within the composition (e.g., EC) is from 0.01% to 40%, from 0.01% to 0.1%, from 0.1% to 0.5%, from 0.5% to 1%, from 0.1% to 0.3%, from 0.3% to 0.5%, from 0.5% to 0.7%, from 0.7% to 1%, from 1% to 1.5%, from 1.5% to 2%, from 2% to 2.5%, from 2.5% to 3%, from 3% to 3.5%, from 3.5% to 4%, from 4% to 5%, from 5% to 6%, from 6% to 7%, from 7% to 8%, from 8% to 10%, from 10% to 20%, from 20% to 30%, from 30% to 40%, from 40% to 50%, including any range or value therebetween.

In some embodiments, the composition is an agricultural composition comprising an agriculturally effective amount of the sulfide compound, and an agriculturally effective amount of the surfactant. In some embodiments, the agriculturally effective amount is sufficient so as to induce or enhance bud break in a plant. In some embodiments, the agriculturally effective amount is sufficient for enhancement of bud break in a plant by at least 10%, at least 20%, at least 40%, at least 60%, at least 80%, at least 100%, at least 200%, at least 300%, at least 400%, at least 500%, at least 600%, at least 700%, at least 800%, at least 1000%, compared to a control (the control is as described herein e.g., a single administration of any one of the sulfide compound or of the surfactant). In some embodiments, the agriculturally effective amount is a synergistically effective amount of the sulfide compound and of the surfactant (e.g. of the active ingredients). In some embodiments, the synergistically effective amount refers to a concentration/amount of any of the sulfide compound and of the surfactant, sufficient for induction or enhancement of a synergistic bud breaking effect on a plant treated by the composition or the kit of the invention. In some embodiments, the synergistic effect comprises induction or enhancement of dormancy release by at least 10%, at least 20%, at least 50%, at least 100%, at least 200%, at least 500%, including any range between, of a plant treated with the composition or the kit of the invention, as compared to a control. In some embodiments, the terms “agriculturally effective amount”, “synergistically effective amount” and “effective amount” are used herein interchangeably.

In some embodiments, the composition or the agricultural composition of the invention comprises an effective amount of the active ingredients, as described herein, wherein the effective amount is sufficient to precede dormancy release of a plant by at least 1 day(d), at least 3 d, at least 6 d, at least 10 d, at least 15 d, at least 20 d, at least 30 d, as compared to a control including any range between. In some embodiments, the term “dormancy release” or the term “bud break” refers to at least 10% activation of the dormant buds (e.g. bud break onset). In some embodiments, the terms “dormancy release” and “bud break” are used herein interchangeably. In some embodiments, the term “inducing” including any grammatical form thereof, refers herein to activation (or dormancy release) of at least 10% of buds (also referred to herein as “bursting buds”) out of total bud population. In some embodiments, the term “total bud population” refers to the total number of buds on a plant or a part thereof (such as cane and/or spur). In some embodiments, the term “total bud population” refers to the total number of dormant buds on a plant or a part thereof, prior to bud break induction.

In some embodiments, the effective amount of the active ingredients within the composition or the agricultural composition of the invention is so as to induce dormancy release of a plant, thereby obtaining a portion of the bursting buds being of at least 10%.

In some embodiments, the effective amount of the active ingredients within the composition or the agricultural composition of the invention is sufficient for bud break enhancement (e.g. increased number of bursting buds) by at least 10%, at least 20%, at least 50%, at least 100%, at least 200%, at least 500%, including any range between, as compared to a control, wherein the number of bursting buds (at the treated plant and at the control) is estimated at the same day. In some embodiments, the term “bud break enhancement” refers to an increase in a number or a portion of the bursting buds on a plant by at least 10%, at least 20%, at least 50%, at least 100%, at least 200%, at least 500%, including any range between, as compared to a control. In some embodiments, the term “portion” refers to a number of buds relative to the total bud population.

In some embodiments, the effective amount is so as to precede (or promote) fruit maturation by at least 1 day(d), at least 3 d, at least 6 d, at least 10 d, at least 15 d, at least 20 d, at least 30 d as compared to a control including any range between. Without being limited to any theory, it is postulated that promoting of the bud break by about 3-4 weeks results in promotion of fruit maturation by about 1-2 weeks.

In some embodiments, the control comprises an untreated plant. In some embodiments, the control comprises a plant treated with the sulfide compound, or with the surfactant. In some embodiments, the control comprises a plant treated with a commercially available bud breaking agent (e.g. HC).

In some embodiments, the agricultural composition further comprises a solvent. In some embodiments, the solvent is an aqueous solvent. In some embodiments, the solvent comprises an aqueous solvent and/or an additional solvent. In some embodiments, the additional solvent is a polar organic solvent. In some embodiments, the additional solvent is a water-miscible solvent.

Non-limiting examples of polar organic solvents include but are not limited to acetone, methanol, ethanol, isopropanol, butanol, pentanol, dimethyl formamide (DMF), N-methylpyrrolidone (NMP), dimethyl sulfoxide (DMSO), and acetonitrile (ACN) or any combination thereof.

In some embodiments, the w/w concentration of the additional solvent within the composition is at most 10%, at most 8%, at most 5%, at most 3%, at most 2%, at most 1%, at most 0.5%, at most 0.1%, at most 0.05%, at most 0.001%, including any range or value therebetween.

In some embodiments, the aqueous solvent comprises water, an aqueous buffer, an aqueous salt solution or any combination thereof.

In some embodiments, the composition further comprises an additive. In some embodiments, a w/w concentration of the additive within the composition is in a range between 0.001 and 50%. In some embodiments, the additive comprises any of a plant nutrient, a fertilizer, a sticking agent, a buffer, a defoaming agent, a thickener, or any combination thereof.

In some embodiments, a w/w concentration of the additive within the formulation or the agricultural composition is from 0.001% to 10%, from 0.01% to 0.1%, from 0.1% to 0.5%, from 0.5% to 1%, from 0.1% to 0.3%, from 0.3% to 0.5%, from 0.5% to 0.7%, from 0.7% to 1%, from 1% to 1.5%, from 1.5% to 2%, from 2% to 2.5%, from 2.5% to 3%, from 3% to 3.5%, from 3.5% to 4%, from 4% to 5%, from 5% to 6%, from 6% to 7%, from 7% to 8%, from 8% to 10% including any range or value therebetween.

In some embodiments, the formulation comprises a tackifier or adherent. Such agents are useful for combining the compound of the invention with carriers to yield a coating composition. Such compositions may aid to maintain contact between the compound of the invention or a composition containing thereof, and a weed.

In some embodiments, an adherent is selected from the group consisting of: alginate, a gum, a starch, a lecithin, formononetin, polyvinyl alcohol, alkali formononetinate, hesperetin, polyvinyl acetate, a cephalin, Gum Arabic, Xanthan Gum, Mineral Oil, Polyethylene Glycol (PEG), Polyvinyl pyrrolidone (PVP), Arabino-galactan, Methyl Cellulose, PEG 400, Chitosan, Polyacrylamide, Polyacrylate, Polyacrylonitrile, Glycerol, Triethylene glycol, Vinyl Acetate, Gellan Gum, Polystyrene, Polyvinyl, Carboxymethyl cellulose, Gum Ghatti, and a polyoxyethylene-polyoxybutylene block copolymer. Other examples of adherent compositions that can be used in the synthetic preparation include those described in EP 0818135, CA 1229497, WO 2013090628, EP 0192342, WO 2008103422 and CA 1041788.

In some embodiments, the composition is substantially devoid of any additive and/or any solvent. In some embodiments, the composition is in a form of a concentrate, e.g. a dilutable concentrate. In some embodiments, the composition is in a form of an emulsion or suspension. In some embodiments, the composition is in a form of a dispersion. In some embodiments, the composition (e.g. the concentrate) is dilutable or dispersible in water.

In some embodiments, the sulfide compound is substantially water immiscible. In some embodiments, the surfactant induces or enhances water miscibility of the sulfide compound. In some embodiments, the surfactant stabilizes the composition (e.g. concentrate) or the aqueous composition (e.g. a diluted composition). In some embodiments, the effective amount (e.g. the w/w ratio between the surfactant and the sulfide compound, as described herein) of the surfactant is sufficient so as to stabilize the composition (e.g. prevent chemical decomposition, retain physical appearance or physico-chemical properties, and/or prevent phase separation of the composition).

In some embodiments, the composition of the invention or the agricultural composition is an aqueous composition. In some embodiments, the composition is a dilute (or ready for administration) aqueous composition. In some embodiments, the composition is a dilute sprayable composition. In some embodiments, the dilute composition comprises the concentrate (e.g., EC) and a sufficient amount of water. In some embodiments, the aqueous composition is substantially stable up to a dilution ratio of 1:2, 1:3, 1:5, 1:7, 1:10, 1:20, 1:30, 1:50, 1:100, including any range between. In some embodiments, dilution refers to the dilution with an aqueous solution.

In some embodiments, the aqueous composition is in a form of an emulsion (w/o, o/w), a suspension or both. In some embodiments, the aqueous composition is stable (e.g., substantially devoid of chemical and/or physical decomposition, and/or phase separation) for at least 1 month(m), at least 6 m, at least 12 m, at least 18 m, at least 24 m, including any range or value therebetween. In some embodiments, the term “stable” including any grammatical forms thereof, refers to the chemical or physical stability of the composition including any one of the active ingredients; a capability of the composition to retain its physical properties (such as appearance, homogeneity, concentration of the active agents, etc.); and/or to a capability of the composition to substantially retain its biological activity.

In some embodiments, a stable composition is substantially devoid of phase separation.

In some embodiments, the aqueous composition is stable upon prolonged storage at a temperature of between −10 and 80° C., wherein prolonged storage comprises at least 1 month(m), at least 6 m, at least 12 m, at least 18 m, at least 24 m, including any range or value therebetween.

In some embodiments, the aqueous composition of the invention is formulated for administration by spraying or by irrigating. In some embodiments, the aqueous composition of the invention is formulated so as for administration by spraying (e.g., having a viscosity, density sufficient for forming an aerosol). Other physical parameters required for the spray able composition are well-known in the art. In some embodiments, the terms “agricultural composition” and “aqueous composition” are used herein interchangeably.

In some embodiments, the concentration of the concentrate (e.g., EC) within the aqueous composition is between 1 and 20% w/w, between 1 and 5% w/w, between 5 and 8% w/w, between 8 and 10% w/w, between 10 and 12% w/w, between 12 and 15% w/w, between 15 and 20% w/w, including any range or value therebetween.

In some embodiments, an agriculturally effective w/w concentration of the sulfide compound within the aqueous composition of the invention is from 0.1 to 20%, from 0.1 to 0.5%, from 0.5 to 1%, from 1 to 3%, from 3 to 5%, from 5 to 6%, from 6 to 7%, from 7 to 8%, from 8 to 10%, including any range or value therebetween. In some embodiments, an agriculturally effective (e.g. synergistically effective) w/w concentration of the sulfide compound within the aqueous composition of the invention is at least 0.5% by total weight of the composition.

In some embodiments, an agriculturally effective w/w concentration of the surfactant within the aqueous composition of the invention is from 0.1 to 20%, from 0.1 to 0.5%, from 0.5 to 1%, from 1 to 3%, from 3 to 5%, from 5 to 6%, from 6 to 7%, from 7 to 8%, from 8 to 10%, including any range or value therebetween.

In some embodiments, a synergistically effective amount comprises (i) a w/w concentration of the surfactant within the agricultural composition of the invention from 0.1 to 20%, from 0.5 to 20%, from 0.5 to 15%, from 0.1 to 0.5%, from 0.5 to 1%, from 1 to 3%, from 3 to 5%, from 5 to 6%, from 6 to 7%, from 7 to 8%, from 8 to 10%, including any range or value therebetween; and (ii) a w/w concentration of the sulfide compound from 0.1 to 10%, from 0.1 to 8%, from 0.5 to 10%, from 0.5 to 8%, from 0.5 to 7%, from 0.5 to 6%, from 3 to 5%, from 5 to 6%, from 6 to 7%, from 7 to 8%, including any range or value therebetween. Without being limited to any theory or mechanism, it is presumed that the maximum synergistic effect of the composition is maintained when the w/w concentration of the sulfide compound within the agricultural composition of the invention ranges from about 0.1 to 10%, from about 0.3 to 8%, from about 0.3 to 7%, or from about 0.5 to 8%, including any range or value therebetween, and wherein the w/w concentration of the surfactant is as describe herein (e.g. between 0.1 and 20, between 0.1 and 15, or between 0.5 and 15% including any range or value therebetween).

In some embodiments, a w/w ratio between the sulfide compound and the surfactant within the aqueous composition of the invention is between 5:1 and 1:1, between 5:1 and 4:1, between 4:1 and 3:1, between 3:1 and 2:1, between 2:1 and 1:1, including any value therebetween.

In some embodiments, a pH of the aqueous composition is from 4 to 9, from 5 to 8, from 6 to 8, from 6.5 to 7, from 7.5 to 8, including any range or value therebetween.

In some embodiments, the composition and/or the aqueous composition of the invention is substantially non-phytotoxic.

In another embodiment of the invention, there is a kit or a combined preparation comprising a first component comprising the sulfide compound of the invention and a second component comprising the surfactant of the invention; wherein the surfactant comprises a poly(ethylene glycol-co-propylene glycol)-based polymer including any derivative thereof.

In some embodiments, the kit comprises the sulfide compound and the surfactant of the invention.

In some embodiments, a w/w concentration of the sulfide compound within the first component is between 0.1 and 99.9% including any range or value therebetween.

In some embodiments, a w/w concentration of the surfactant within the second component is between 0.1 and 99.9% including any range or value therebetween.

In some embodiments, the kit comprises instructions for mixing the first component and the second component, so as to obtain a mixture wherein a w/w ratio between the sulfide compound and the surfactant within the mixture is between 20:1 and 1:20, between 20:1 and 15:1, between 15:1 and 10:1, between 10:1 and 1:1, between 10:1 and 8:1, between 8:1 and 5:1, between 5:1 and 3:1, between 3:1 and 2:1, between 2:1 and 1:1, between 1:1 and 1:20, between 1:1 and 1:15, between 1:1 and 1:10, between 1:1 and 1:5, between 1:5 and 1:20, between 1:5 and 1:15, between 1:10 and 1:20, including any range between. In some embodiments, the mixture is the aqueous composition of the invention, wherein the concentrations and the ratios of the ingredients within the aqueous composition are as described hereinabove.

In some embodiments, the agricultural composition or the kit of the invention comprises the surfactant of the invention and the sulfide compound of the invention, wherein (i) a w/w ratio between the sulfide compound and the surfactant within the agricultural composition or the kit is between 20:1 and 1:20, between 20:1 and 15:1, between 15:1 and 1:1, between 15:1 and 13:1, between 13:1 and 12:1, between 12:1 and 10:1, between 10:1 and 1:1, between 10:1 and 8:1, between 8:1 and 5:1, between 5:1 and 1:1, between 5:1 and 4:1, between 4:1 and 3:1, between 3:1 and 2:1, between 2:1 and 1:1, between 1:1 and 1:20, between 1:1 and 1:15, between 1:1 and 1:2, between 1:2 and 1:7, between 1:7 and 1:10, between 1:10 and 1:15, between 1:15 and 1:20, including any value therebetween; and wherein (ii) a concentration of the surfactant of the invention and of the sulfide compound of the invention within the agricultural composition or the kit is as described hereinabove (e.g. an agriculturally effective w/w concentration of the surfactant and/or of the sulfide compound ranging from 0.1 to 20%, from 0.1 to 0.5%, from 0.5 to 1%, from 1 to 3%, from 3 to 5%, from 5 to 6%, from 6 to 7%, from 7 to 8%, from 8 to 10%, including any range or value therebetween).

### The Method

According to another aspect, there is provided a method for enhancing or inducing bud break in a plant, comprising contacting the plant with the composition of the invention (e.g. the agricultural composition), or with the kit of the invention.

In some embodiments, the method comprises contacting the plant with the kit of the invention, wherein the first component and the second component are administered concomitantly (as a combined preparation) or subsequently.

Further, as used herein, the terms “combined”, “combination” and the like, including terms such as “together with”, referring the combined administration of various compounds, are meant to cover any possible combination of the administered materials, including administering two or more materials in a single formulation, administering two or more materials in two or more separate formulations, at the same time, consecutively, at different times, at the same intervals, at different intervals, or any combination thereof. If more than two materials are administered, any of the materials may be combined with any of the other materials, by any of the means detailed above, without being dependent on one another.

In some embodiments, the method further comprises repeating the administration of the composition (e.g. the agricultural composition) or the kit of the invention to the plant. In some embodiments, the method comprises repeating the administration 2, 3, 4, 5, or more additional times.

In some embodiments, the plant is a perennial plant. In some embodiments, the plant is a deciduous plant. Non-limiting examples of plants include but are not limited to grapevine, kiwi, rosacea, nuts, citrus, avocado, apple, plum, peach or any combination thereof.

In some embodiments, contacting comprises administering the composition (e.g. the agricultural composition) or the kit to plant bulbs, plant tubers, plant roots, plant branches, plant trunk or any combination thereof.

In some embodiments, administering comprises contacting the agricultural composition of the invention with the plant, wherein a w/w concentration of the sulfide compound and/or of the surfactant of the invention within the agricultural composition is between 0.1 and 20%, between 0.1 and 15%, between 0.1 and 10%, between 0.5 and 1%, between 1 and 3%, between 3 and5%, between 5 and 8%, between 8 and 10%, between 10 and 13%, between 10 and 15%, between 10 and 20%, between 13 and 15%, between 15 and 20%, between 13 and 20% including any range between. In some embodiments, a w/w concentration of the surfactant within the agricultural composition is between 0.01 and 10% or between 0.01 and 20% including any range between.

In some embodiments, contacting comprises exposing the plant to an effective concentration of the active ingredients of the composition or the kit of the invention, wherein the active ingredients are as described herein.

In some embodiments, the method is for enhancing or inducing bud break in a plant.

In some embodiments, the method is for enhancing or inducing bud break in a plant by administering to the plant or soil, the aqueous composition or the kit described hereinabove.

In some embodiments, the term “enhancing”, or any grammatical derivative thereof, indicates that at least 5%, 10%, 20%, 30%, 40%, 50%, 60%, 70%, 80%, 90%, or more, enhancement of bud break in a given time as compared to the bud break in that given time (e.g. at the same day) not being exposed to the treatment as described herein. In some embodiments, the term “bud break” is as described hereinabove. In some embodiments, the term “inducing bud break” is as described hereinabove.

In some embodiments, the term “enhancing”, or any grammatical derivative thereof, indicates that at least 5%, 10%, 20%, 30%, 40%, 50%, 60%, 70%, 80%, 90%, at least 100%, at least 200%, at least 500%, including any range between, or more, enhancement of bud break (e.g. increased number of bursting buds) within a given time period, as compared to a control within the same time period. In some embodiments, enhancing bud break refers to increasing the number of bursting buds (e.g. by at least 10%, 20%, 30%, 40%, 50%, 60%, 70%, 80%, 90%, at least 100%, at least 200%, at least 500), as compared to the control. In some embodiments, the number of bursting buds of the treated plant and of the control is assessed at the same time point (e.g. a time period upon dormancy release onset). One skilled in the art will appreciate, that the bud break enhancement may be assessed by counting of bursting buds, e.g. as described in the Examples section.

In some embodiments, the term “bud break enhancement” refers to an increase of a portion of the bursting buds on a plant by at least 5%, 10%, at least 20%, at least 50%, at least 100%, at least 200%, at least 500%, including any range between, as compared to a control, wherein the portion of bursting buds (at the treated plant and at the control) is estimated at the same day. In some embodiments, the term “portion” refers to a number of buds relative to the total bud population.

In some embodiments, the control is a single administration of the sulfide compound, or of the surfactant (e.g. not in a form of a combination or a composition containing both the surfactant and the sulfide compound). In some embodiments, the control comprises a single administration of the same amount (e.g. weight per cultivated area or per plant) of the sulfide compound, or of the surfactant. In some embodiments, the control is as described herein.

In some embodiments, enhancing bud break comprises enhancing dormancy release rate by at least 10%, 20%, at least 30%, at least 40%, at least 50%, at least 60%, at least 70%, at least 80%, at least 90%, at least 100%, at least 200%, at least 300%, at least 500%, at least 700%, at least 1000%, including any range between, compared to a control.

In some embodiments, the dormancy release rate refers to a time period ranging from bud break onset (as described hereinabove) until activation of about 80% from the total dormant buds.

In some embodiments, the composition of the invention is characterized by an enhanced dormancy release rate (when applied to the plant according to the method of the invention) compared to a control by at least 20%, at least 30%, at least 40%, at least 50%, at least 60%, at least 70%, at least 80%, at least 90%, at least 100%, at least 200%, at least 300%, at least 500%, at least 700%, at least 1000%, including any range between.

In some embodiments, the composition of the invention is characterized by dormancy release rate (when applied to the plant according to the method of the invention) of between 3 and 10 d, between 3 and 5 d, between 5 and 7 d, between 7 and 10 d, including any range between.

In some embodiments, the composition of the invention is characterized by dormancy release rate (when applied to the plant according to the method of the invention) of at most 10 d, at most 7 d, at most 5 d, at most 4 d, including any range between, wherein release rate is as described herein.

In some embodiments, inducing bud break comprises preceding dormancy release onset of the plant by at least 1 day(d), at least 3 d, at least 6 d, at least 10 d, at least 15 d, at least 20 d, at least 30 d, at least 50 d, at least 1 month, at least 2 months, at least 3 months, at least 4 months, or more, as compared to a control (e.g. untreated plant), including any range between. A skilled artisan will appreciate that the dormancy release onset can be promoted or preceded by a predetermined time period (e.g. of between several days and several months), depending on the time point of the application of the composition and/or kit of the invention. Furthermore, a skilled artisan may adjust the predetermined dormancy release onset, according to the desired harvesting time. Usually, the dormancy release onset occurs 2-4weeks after application of the composition and/or kit of the invention. The predetermined time period may vary, depending on the growth conditions (e.g. ambient temperature, exposure to light and light intensity, etc.).

In some embodiments, the method is for advancing blooming in a plant. In some embodiments, advancing blooming comprises preceding or promoting blooming in a plant by at least 1 day(d), at least 3 d, at least 6 d, at least 10 d, at least 15 d, at least 20 d, at least 30 d, at least 50 d, at least 1 month, at least 2 months, at least 3 months, at least 4 months, or more, as compared to a control (e.g. untreated plant), including any range between. A skilled artisan will appreciate that the blooming onset can be promoted or preceded by a predetermined time period (e.g. of between several days and several months), depending on the time point of the application of the composition and/or kit of the invention. Furthermore, a skilled artisan may adjust the predetermined blooming onset, according to the desired harvesting time. In some embodiments, the method is for advancing harvesting time.

In some embodiments, the method is for enhancing yield of the plant as compared to the control. In some embodiments, the method is for enhancing yield of the plant, wherein enhancing is as described herein.

In some embodiments, the method is for enhancing or inducing a substantially uniform bud break in a plant. In some embodiments, uniform bud break comprises substantially uniform activation of the buds (e.g. basal buds and/or central buds) along the cane and/or spur. In some embodiments, uniform bud break refers to a portion of the bursting proximal buds (e.g. basal buds and/or central buds) being substantially the same (e.g. at least 70%, at least 80%, at least 90% identity) as the portion of the bursting distal buds (e.g. located at the distal end of the cane), wherein the portion refers to a percentage of the bursting buds from the total number of the dormant buds within the cane (distal buds or proximal buds, respectively). In some embodiments, uniform bud break refers to a ratio between the bursting proximal buds and the bursting distal buds (e.g. located at the distal end of the cane) within the same plant or cane. In some embodiments, the term distal or proximal refers to the distance from the branch (as illustrated in FIG. 2). In contrast, a non-uniform bud break is characterized by a predominant release of the distal buds, together with only moderate release of the proximal buds (based on FIG. 3).

In some embodiments, the method is for enhancing bud break uniformity (e.g. a ratio between the portion of the bursting proximal buds and the portion of the bursting distal buds) as compared to the control, and calculated within the same given time period. In some embodiments, enhancing bud break uniformity is by at least 20%, at least 50%, at least 60%, at least 70%, at least 80%, at least 90%, including any range between.

In some embodiments, uniform bud break refers to a substantially the same dormancy release rate (e.g. at least 70%, at least 80%, at least 90% identity) of the distal buds and of the proximal buds on a plant.

In some embodiments, the given time period ranges between 3 d and 4 weeks, between 3 d and 1 week (w), between 1 and 2 w, between 2 and 3 w, between 3 and 4 w, including any range between. In some embodiments, the given time period refers to a time period subsequent to the application or treatment of the plant by the composition or kit of the invention. In some embodiments, the given time period refers to a time period subsequent or starting from the dormancy release onset.

In some embodiments, the plant is selected from the group consisting of: a plant, parts of the plant, area under cultivation and growth medium (such as soil) or any combination thereof.

As used herein, the terms “contacting” or “exposing” comprise: immersion, coating, irrigating, dipping, spraying, fogging, scattering, painting, injecting, or any combination thereof. In some embodiments, the terms “contacting”, “exposing” and “applying” including any grammatical form thereof, are used herein interchangeably.

In some embodiments, the agricultural composition or kit is applied to the soil (or to the area under cultivation) and/or to the plant using methods known in the art. These include but are not limited to: (a) drip irrigation or chemigation; (b) soil incorporation; (c) seed treatment.

In some embodiments, the agricultural composition or kit is applied to plants. In some embodiments, the agricultural composition is applied to the whole plant and/or to at least one plant part. In some embodiments, the plant or plant part may be rooted in the soil or hydroponics, open field, greenhouse etc. In some embodiments, the composition is applied to one or more plant parts selected from, but not limited to: shoot, leaf, flower, root, leaves, needles, stalks, stems, flowers, fruit bodies, seeds, roots, harvested material, vegetative and generative propagation material tubers, cuttings, offshoots, rhizomes and all parts and organs of plants above and below the ground.

As used herein, the term “growth medium” is related to any growth substrate including soil.

In some embodiments, the composition is exposed to the growth medium at a dosage ranging from 0.3 to 30 g/m², from 0.3 to 1 g/m², from 1 to 5 g/m², from 2 to 5 g/m², from 1 to 10 g/m², from 5 to 10 g/m², from 10 to 30 g/m², from 10 to 20 g/m², from 20 to 30 g/m² including any range or value therebetween.

In some embodiments, the composition is exposed to the growth medium at a dosage ranging from 1 to 120 g/m³, from 1 to 10 g/m³, from 10 to 20 g/m³, from 20 to 30 g/m³, from 30 to 40 g/m³, from 40 to 50 g/m³, from 50 to 60 g/m³, from 60 to 70 g/m³, from 70 to 80 g/m³, from 80 to 100 g/m³, from 100 to 120 g/m³, including any range or value therebetween.

In some embodiments, contacting comprises exposing the plant to (or contacting the plant with) an effective amount of the composition or of the kit of the invention, wherein the effective amount is sufficient for inducing bud break in the plant. In some embodiments, contacting comprises exposing the plant to (or contacting the plant with) an effective amount of the composition or of the kit of the invention, wherein the effective amount is sufficient for substantial (e.g. at least 50%, at least 70%, at least 80%, at least 90%, at least 95% or more, including any range between) wetting of the plant.

In some embodiments, the effective amount (e.g. sufficient for substantial wetting of the plant) is or comprises between 100 and 10.000 liter of the composition or of the kit per hectare area under cultivation (l/ha), between 100 and 2.000 l/ha, between 200 and 2.000 l/ha, between 300 and 2.000 l/ha, between 400 and 2.000 l/ha, between 300 and 10.000 l/ha, between 100 and 500 l/ha, between 500 and 1.000 l/ha, between 1.000 and 2.000 l/ha, between 1.000 and 10.000 l/ha, between 2.000 and 10.000 l/ha, between 2.000 and 5.000 l/ha, between 3000 and 10.000 l/ha, between 3000 and 5.000 l/ha, between 5000 and 7.000 l/ha, between 7000 and 10.000 l/ha, including any range or value therebetween. One skilled in the art will appreciate that the exact effective amount may vary depending inter alia on a plant specie, plant density within the orchard, specific climatic conditions, application time and the desired dormancy release advance, etc.

In some embodiments, the effective amount is as described herein, wherein the composition or the kit comprises the surfactant and the sulfide compound of the invention at an agriculturally effective w/w concentration as described herein (e.g. between about 0.1 and about 20%, or between about 0.5 and about 15%, including any range between). In some embodiments, the effective amount is as described herein, wherein the composition or the kit comprises the surfactant and the sulfide compound of the invention at an agriculturally effective w/w concentration and/or at a w/w ratio as described herein (e.g. a ratio between the sulfide compound and the surfactant in a range between 20:1 and 1:20, or between 15:1 and 1:15, or between 15:1 and 1:5, or between 10:1 and 1:2, including any range between).

In some non-limiting embodiments of the invention, the composition is applied to the plant at a dosage sufficient for a substantial coverage of the plant buds.

### Definitions

As used herein, the term “alkyl” describes an aliphatic hydrocarbon including straight chain and branched chain groups. The term “alkyl”, as used herein, also encompasses saturated or unsaturated hydrocarbon, hence this term further encompasses alkenyl and alkynyl.

The term “alkenyl” describes an unsaturated alkyl, as defined herein, having at least two carbon atoms and at least one carbon-carbon double bond. The alkenyl may be substituted or unsubstituted by one or more substituents, as described hereinabove.

The term “alkynyl”, as defined herein, is an unsaturated alkyl having at least two carbon atoms and at least one carbon-carbon triple bond. The alkynyl may be substituted or unsubstituted by one or more substituents, as described hereinabove.

The term “cycloalkyl” describes an all-carbon monocyclic or fused ring (i.e. rings which share an adjacent pair of carbon atoms) group where one or more of the rings does not have a completely conjugated pi-electron system. The cycloalkyl group may be substituted or unsubstituted, as indicated herein.

The term “aryl” describes an all-carbon monocyclic or fused-ring polycyclic (i.e. rings which share adjacent pairs of carbon atoms) groups having a completely conjugated pi-electron system. The aryl group may be substituted or unsubstituted, as indicated herein.

The term “alkoxy” describes both an O-alkyl and an —O-cycloalkyl group, as defined herein. The term “aryloxy” describes an —O-aryl, as defined herein.

Each of the alkyl, cycloalkyl and aryl groups in the general formulas herein may be substituted by one or more substituents, whereby each substituent group can independently be, for example, halide, alkyl, alkoxy, cycloalkyl, nitro, amino, hydroxyl, thiol, thioalkoxy, carboxy, amide, aryl and aryloxy, depending on the substituted group and its position in the molecule. Additional substituents are also contemplated.

The term “halide”, “halogen” or “halo” describes fluorine, chlorine, bromine or iodine. The term “haloalkyl” describes an alkyl group as defined herein, further substituted by one or more halide(s). The term “haloalkoxy” describes an alkoxy group as defined herein, further substituted by one or more halide(s). The term “hydroxyl” or “hydroxy” describes a —OH group. The term “mercapto” or “thiol” describes a —SH group. The term “thioalkoxy” describes both an —S-alkyl group, and a —S-cycloalkyl group, as defined herein. The term “thioaryloxy” describes both an —S-aryl and a —S-heteroaryl group, as defined herein. The term “amino” describes a —NR′R″ group, or a salt thereof, with R′ and R″ as described herein.

The term “heterocyclyl” describes a monocyclic or fused ring group having in the ring(s) one or more atoms such as nitrogen, oxygen and sulfur. The rings may also have one or more double bonds. However, the rings do not have a completely conjugated pi-electron system. Representative examples are piperidine, piperazine, tetrahydrofuran, tetrahydropyran, morpholino and the like.

The term “carboxy” describes a —C(O)OR′ group, or a carboxylate salt thereof, where R′ is hydrogen, alkyl, cycloalkyl, alkenyl, aryl, heteroaryl (bonded through a ring carbon) or heterocyclyl (bonded through a ring carbon) as defined herein. or “carboxylate”

The term “carbonyl” describes a —C(O)R′ group, where R′ is as defined hereinabove. The above-terms also encompass thio-derivatives thereof (thiocarboxy and thiocarbonyl).

The term “thiocarbonyl” describes a —C(S)R′ group, where R′ is as defined hereinabove. A “thiocarboxy” group describes a —C(S)OR′ group, where R′ is as defined herein. A “sulfinyl” group describes an —S(O)R′ group, where R′ is as defined herein. A “sulfonyl” or “sulfonate” group describes an —S(O)2R′ group, where R′ is as defined herein.

A “carbamyl” or “carbamate” group describes an —OC(O)NR′R″ group, where R′ is as defined herein and R″ is as defined for R′. A “nitro” group refers to a —NO2 group. The term “amide” as used herein encompasses C-amide and N-amide. The term “C-amide” describes a —C(O)NR′R″ end group or a —C(O)NR′— linking group, as these phrases are defined hereinabove, where R′ and R″ are as defined herein. The term “N-amide” describes a —NR″C(O)R′ end group or a —NR′C(O)— linking group, as these phrases are defined hereinabove, where R′ and R″ are as defined herein.

A “cyano” or “nitrile” group refers to a —CN group. The term “azo” or “diazo” describes an —N═NR′ end group or an —N═N— linking group, as these phrases are defined hereinabove, with R′ as defined hereinabove. The term “guanidine” describes a —R′NC(N)NR″R″′ end group or a —R′NC(N)NR″— linking group, as these phrases are defined hereinabove, where R′, R″ and R″′ are as defined herein. As used herein, the term “azide” refers to a —N3 group. The term “sulfonamide” refers to a —S(O)2NR′R″ group, with R′ and R″ as defined herein.

The term “phosphonyl” or “phosphonate” describes an —OP(O)—(OR′)2 group, with R′ as defined hereinabove. The term “phosphinyl” describes a —PR′R″ group, with R′ and R″ as defined hereinabove. The term “alkylaryl” describes an alkyl, as defined herein, which substituted by an aryl, as described herein. An exemplary alkylaryl is benzyl.

As used herein, the terms “halo” and “halide”, which are referred to herein interchangeably, describe an atom of a halogen, that is fluorine, chlorine, bromine or iodine, also referred to herein as fluoride, chloride, bromide and iodide.

In some embodiments, each of R, and R₁ independently represents one or more substituents. In some embodiments, the term “one or more” refers to any numerical value selected form of 1, 2, 3, 4, 5, or 6.

In some embodiments, the term “substituted” encompasses a substitution by one or more substituents independently selected from the group comprising: (C₀-C₆)alkyl-aryl, (C₀-C₆)alkyl-heteroaryl, (C₀-C₆)alkyl-(C₃-C₈) cycloalkyl, optionally substituted C₃-C₈ heterocyclyl, halogen, —NO₂, —CN, —OH, —CONH₂, —CONR″₂, —CNNR″₂, —CSNR″₂, —CONH—OH, —CONH—NH₂, —NHCOR″, —NHCSR″, —NHCNR″, —NC(═O)OR″, —NC(═O)NR″, —NC(═S)OR″, —NC(═S)NR″, —SO₂R″, —SOR″, —SR″, —SO₂OR″, —SO₂N(R)₂, —NHNR₂, —NNR, C₁-C₁₀ haloalkyl, optionally substituted C₁-C₁₀ alkyl, —NH₂, —NH(C₁-C₁₀ alkyl), —N(C₁-C₁₀ alkyl)₂, C₁-C₁₀ alkoxy, C₁-C₁₀ haloalkoxy, hydroxy(C₁-C₁₀ alkyl), hydroxy(C₁-C₁₀ alkoxy), alkoxy(C₁-C₁₀ alkyl), alkoxy(C₁-C₁₀ alkoxy), C₁-C₁₀ alkyl-NR″₂, C₁-C₁₀ alkyl—SR, —CONH(C₁-C₁₀ alkyl), —CON(C₁-C₁₀ alkyl)₂, —CO₂H, —CO₂R″, —OCOR″, —OCOR″, —OC(═O)OR″, —OC(═O)NR″, —OC(═S)OR″, or —OC(═S)NR″, including any combination thereof, wherein R″ is selected from the group comprising an optionally substituted C₁-C₁₀ alkyl, an optionally substituted C₃-C₁₀ cycloalkyl, an optionally substituted C₃-C₁₀ heterocyclyl, an C₁-C₁₀ alkyl-aryl, an C₁-C₁₀ alkyl-cycloalkyl, an optionally substituted heteroaryl, an optionally substituted aryl, or a combination thereof.

### General

As used herein the term “about” refers to ±10%.

The terms “comprises”, “comprising”, “includes”, “including”, “having” and their conjugates mean “including but not limited to”. The term “consisting of” means “including and limited to”. The term “consisting essentially of” means that the composition, method or structure may include additional ingredients, steps and/or parts, but only if the additional ingredients, steps and/or parts do not materially alter the basic and novel characteristics of the claimed composition, method or structure.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

As used herein the term “substantially” refers at least 60%, at least 70%, at least 80%, at least 85%, at least 90%, at least 95%, at least 97%, at least 99%, at least 99.9%, including any rage or value therebetween. In some embodiments, the terms “substantially” and the term “consisting essentially of” are used herein interchangeably.

As used herein, the term “plurality” encompasses any integer equal to or greater than 2. In some embodiments, a plurality comprises at least 2, at least 3, at least 4, at least 5, at least 6, at least 7, at least 8, at least 9, or at least 10, or any value and range therebetween. Each possibility represents a separate embodiment of the invention. As used herein, the term “plurality” may refer to the plurality of the same species or to plurality of different species.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

In some embodiments, the term “consists essentially of” or variations such as “consist essentially of” or “consisting essentially of” as used throughout the specification and claims, indicate the inclusion of any recited integer or group of integers, and the optional inclusion of any recited integer or group of integers that do not materially change the basic or novel properties of the specified method, structure or composition.

As used herein, the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

As used herein, the term “treating” includes abrogating, substantially inhibiting, slowing or reversing the progression of a condition, substantially ameliorating clinical or aesthetical symptoms of a condition or substantially preventing the appearance of clinical or aesthetical symptoms of a condition.

In those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

### EXAMPLES

### Example 1

### Bud Breaking on Whole Vines in a Vineyard

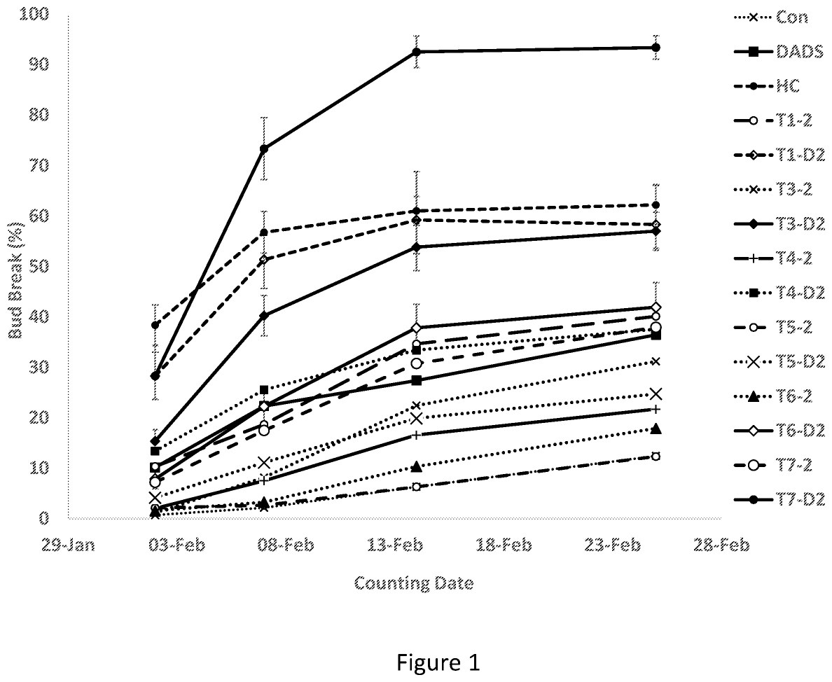

Mature spur-pruned cv. Early Sweet vines in a commercial vineyard in the Jordan Valley were sprayed with exemplary agricultural compositions of the invention comprising 6% w/w of DADS, together with various concentrations (2, 4 and 8% w/w) of the corresponding surfactant. The effect of these treatments was compared with a positive control formulation comprising 5% HC (with 0.025% Triton X-100); as well as with negative control formulations comprising a single treatment with Triton X-100 (abbreviated as “Con”), with the surfactant, or with DADS, respectively. The surfactants utilized in this experiment are represented in Table 1 below. The results of this experiment are summarized in FIGS. 1 and 3.

TABLE 1

| | Chemical name/CAS | Optional chemical structure | Source |
|---|---|---|---|
| T1 | Armobreak N,N- Bis-2-(omega- hydroxy PEG-PPG)- ethylalkylamine)/1258 | 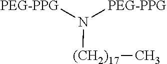 | Akzo Nobel |
| | 305-76-8 | | |
| T3 | Dehypon LS-54, mono alkylated (C12-C14) PEG- PPG/68439-51-0 | 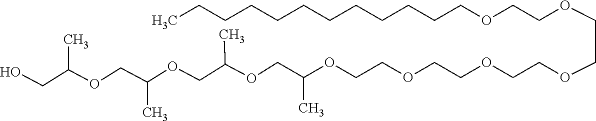 [SMILES: CCCCCCCCCCCCOCCOCCOCCOCCOCCOC(C)COC(C)COC(C)COC(C)CO] | BASF |
| T4 | C9-11 Pareth-3, mono | CH₃(CH₂)ₙ—O(CH₂CH₂O)ₘ, wherein n = 8-10, and m = 3-9 | PCC |
| | alkylated (C9-11) | | Exol |
| | PEG/68439-46-3 | | SA |
| T5 | Surfan SC-147, PEG- PPG-dimethylether/ 61419-46-3 | 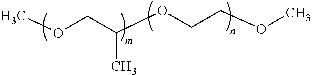 | |
| T6 | Emulgin B25, mono | CH₃(CH₂)ₙ—O(CH₂CH₂O)ₘ, wherein n = 15-17 | BASF |
| | alkylated C16-18 | | |
| | PEG/68439-49-6 | | |
| T7 | EcoSurf EH-9, mono alkylated (2-ethyl- hexyl) PEG-PPG/ 64366-70-7 | 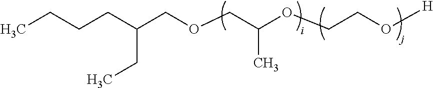 | DOW |

Each formulation was sprayed onto five blocks of two vines, wherein the values presented in FIG. 1 are an average of the ten tested grapevines. Bud breaking efficiency was estimated by counting bursting buds at various time intervals post treatment. Total number of buds was recorded once for each vine, and number of bursting buds were recoded for each vine at 22, 27, 34 and 41 d after treatment.

According to the results presented in FIG. 1, monoalkylated PEG-PPG based surfactants (T3 and T7), when applied together with DADS exhibited an improved bud break efficiency compared to a single administration of DADS or to a single administration of the surfactant, supporting synergistic bud-breaking effect. Surprisingly, structurally similar monoalkylated PEG-based non-anionic surfactants (such as T4 and T6) did not show any significant synergistic effect, when applied together with DADS.

In particular, an exemplary composition of the invention comprising PEG-PPG substituted with a branched alkyl (T7) and DADS, showed superior efficiency and uniformity over commercially available bud-breaking agents (such as HC), and over a combination of a cationic amine-based surfactant (Armobreak®) and DADS.

FIG. 3 represents enhanced bud break uniformity (i.e. uniformity along a spur, see illustration in FIG. 2), as obtained upon treatment with an exemplary composition of the invention (T7-D2). In contrast, treatment of the plants with commercially available bud-breaking agents (HC and Armobreak+DADS) resulted in a significantly less uniform bud break. Specifically, the percentage of basal bud burst in response to T7-D2 treatment is about 3.5 folds higher, compared to that of HC or of Armobreak+DADS.

### Example 2

Mature cane-prunned cv. Scarlota vines in a commercial vineyard in the Lachish were sprayed with an exemplary composition of the invention comprising 6% w/w of DADS, together with 2% w/w of mono alkylated (2-ethylhexyl) PEG-PPG (CAS: 64366-70-7), as the surfactant. Bud breaking efficiency of an exemplary composition of the invention was compared with the bud breaking efficiency of the positive control comprising 5% HC (with 0.025% Triton X-100); as well as with negative controls comprising the T7 surfactant at 2% w/w, DADS at 6% w/w, or Triton X-100 at 0.025% w/w.

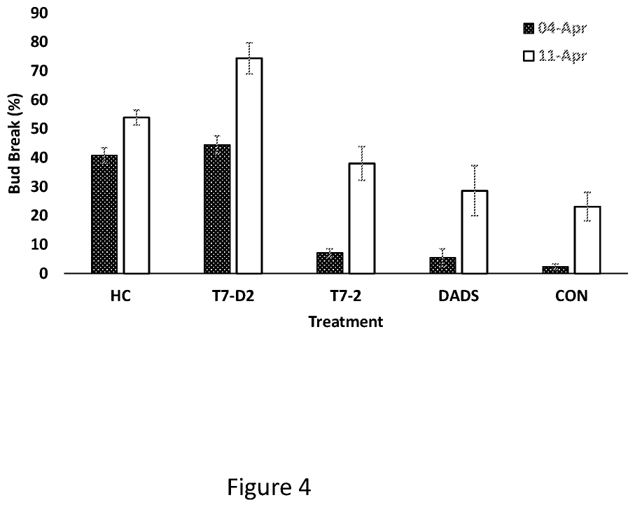

The results of this experiment are summarized in FIG. 4 and present an average bud break count of ten tested grapevines. Total number of buds was recorded once for all canes on each vine, and number of bursting buds on these canes were recorded at 4 weeks (4 Apr) and at 5 weeks (11 Apr) after treatment.

Additionally, the inventors tested a composition comprising DADS at about 6% w/w, and 1% w/w of the PEG-PPG based surfactant (CAS: 64366-70-7) under similar conditions, as described hereinabove. Surprisingly, even at such low concertation of the surfactant the composition exhibited a synergistic bud breaking efficiency. The bud break efficiency of the tested composition (i.e. with 1% w/w of the surfactant) was about 90% of the bud break efficiency of a composition with 2% w/w of the surfactant. Accordingly, it is postulated that compositions of the invention comprising less than 1% w/w of the surfactant (such as 0.5%, or less) may be effective in inducing synergistic bud break of a plant.

### Example 3

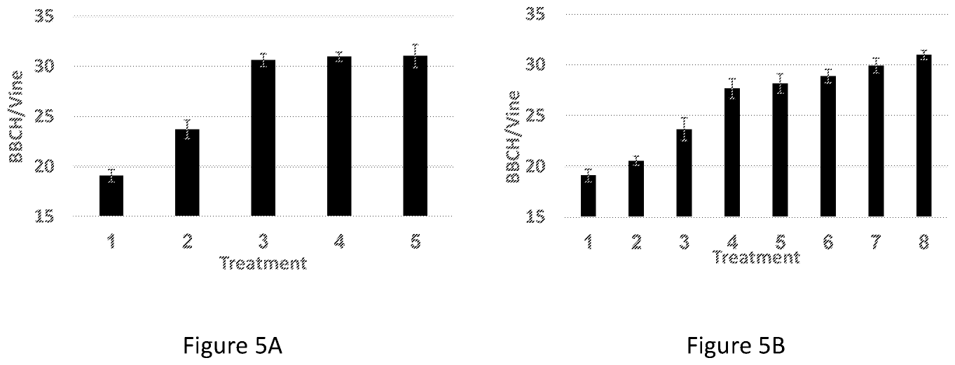

Grapevines in a commercial vineyard in South Africa were sprayed exemplary agricultural compositions of the invention. Two different experimental treatments have been performed on 5 blocks of 14 vines. The bud break efficiency of each treatment has been evaluated by scoring 60 buds per vine according to BBCH scale at different time points after treatment. BBCH values represent average values of five blocks per treatment. The tested exemplary agricultural compositions utilized for each experimental treatment were as follows:
2% w/w of T7 (see Table 1) together with various concentrations (2.5, 5 and 6% w/w) of the sulfide compound (dimethyl disulfide (DMS); and DADS). The effect of these treatments was compared to a commercial formulation comprising 50% HC; as well as to a negative control, i.e. untreated vines. The results of this experiment are represented in FIG. 5A.
6% w/w DADS together with various concentrations (0.5, 1, 2 and 12% w/w) of T7. The effect of these treatments was compared to a commercial formulation comprising 50% HC; as well as to negative controls including untreated plant, and plants treated with 12% w/w T7 and 6% w/w DADS, respectively. The results of this experiment are represented in FIG. 5B.

As shown in FIG. 5A, sulfide compounds other than DADS (e.g. DMS) exhibit synergistic bud-breaking efficiency, when applied together with a surfactant of the invention (e.g. T7). Furthermore, bud-breaking efficiency of the exemplified sulfide compounds (DADS and DMS) is significantly greater than each of the surfactant and the sulfide compound alone (data not shown) and is comparable with the efficiency of commercially available agents (such as HC). As deduced from FIG. 5A, bud break in vine was significantly enhanced from score 19 (untreated plant) to score 24 (2.5% w/w DMS), and to score 30-31 (5% w/w DMS), respectively upon treatment with exemplary compositions of the invention.

The inventors tested an additional sulfide compound (diethyl sulfide), which exhibited synergistic bud-breaking efficiency (e.g. synergistic advancement of bud break), when applied together with a surfactant of the invention (e.g. T7) under similar conditions. Accordingly, it has been postulated that administration of a synergistically effective amount of any of the sulfide compound together with the surfactant of the invention will induce bud break in a plant.

As deduced from FIG. 5B, both the lowest (0.5% w/w) and the highest (12% w/w) tested concentration of T7 were potent and exhibited synergistic bud-breaking efficiency (significantly greater than any of the negative controls) when applied together with DADS. These data support the synergistically effective amount disclosed herein. Based on Figure it is apparent that even the lowest concentration of T7 exhibits almost the same potency as the commercial formulation of HC. Accordingly, the composition and/or kit of the invention can be utilized as an effective alternative to the toxic HC (which is currently banned from agricultural use in various countries).

### Example 4

The inventors performed numerous experiments to assess the effect of application of an exemplary composition of the invention (e.g. about 6% w/w DADS and about 4% w/w T7) on bud break in various plants. For each test from about 500 to about 1500 l/ha of the composition have been applied (e.g. by spraying) to the orchard, to result in almost complete wetting of the treated plants. The tested plant species included kiwi, cherry, apple, and plum. To this end, all treated plants exhibited a significantly advanced bud break (e.g. vegetation onset), compared to untreated plants. In some of the trials, the bud-breaking efficiency (or advancement) was comparable with the efficiency of the commercial formulation (HC) in advancing vegetation and flowering onset. Furthermore, no significant phytotoxicity was observed for the plants treated with an effective amount of the composition of the invention. Both apples and plums showed similar bud break advancement and number of inflorescence when treated with the composition of the invention compared to the positive control (HC).

In trials performed on kiwi and cherry the composition of the invention was superior to HC in both dormancy release rate and number of inflorescences. Specifically, 49 days after treatment with the composition of the invention Kiwi plants showed about 43% bud break and a substantial green foliage coverage (score 5 of 10), whereas the plants treated with HC showed only 24% bud break (almost 2 times less) and only minor foliage coverage (score 2).

Furthermore, application of the composition of the invention to cherry plants resulted in advanced flower bud break and blooming onset, as compared to untreated plants (blooming onset was advanced by about 20 days). Moreover, application of the composition of the invention to cherry plants resulted in increase in number of inflorescences of about 30%, and about 10%, as compared to untreated plants and to the positive control (HC), respectively. Additionally, application of an exemplary composition of the invention (e.g., about 6% w/w DADS and about 4% w/w T7) to cherry plants resulted in significant yield enhancement of the harvested fruits over the untreated plants and over plants treated by HC (about 60% and about 9%, respectfully).

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A composition comprising a sulfide compound and a surfactant; wherein:
(i) a weight per weight (w/w) ratio between said sulfide compound and said surfactant is between 20:1 and 1:2;
(ii) said surfactant comprises an alkylated poly(ethylene glycol-co-propylene glycol) including any derivative thereof, and is substantially devoid of an alkyl amine surfactant; and
(iii) said sulfide compound comprises an alkyl sulfide, an alkenyl sulfide or both.

2. (canceled)

3. The composition of claim 1, wherein said alkylated poly(ethylene glycol-co-propylene glycol) is represented by Formula 1: 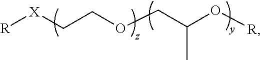
wherein:
each R independently comprises H or a C2-C30 alkyl; wherein X is selected from O, S, CH, CH2 or is absent;
wherein y and z independently represent an integer being between 1 and 100;
and wherein at least one R comprises said C2-C30 alkyl.

4. The composition of claim 3, wherein said C2-C30 alkyl is a linear alkyl or a branched alkyl, optionally comprising (i) at least one unsaturated bond, (ii) at least one substituent, or both (i) and (ii), wherein said branched alkyl comprises 2-ethyl-hexyl.

5. (canceled)

6. The composition of claim 1, wherein said surfactant comprises 2-ethyl-hexyl poly(ethylene glycol-co-propylene glycol).

7. The composition of claim 1, wherein said sulfide compound is represented by Formula 2: R₁—S—(X₁)ₐ—R₁, wherein each R₁ independently comprises H, a C1-C10 alkyl, or a C1-C10 alkenyl, and wherein at least one R₁ comprises C1-C10 alkyl or a C1-C10 alkenyl; wherein X₁ is S or is absent; and wherein a represents an integer between 1 and 5; wherein said C1-C10 alkyl is a linear alkyl or a branched alkyl, optionally comprising (i) an unsaturated bond, (ii) a substituent, or both (i) and (ii).

8. (canceled)

9. The composition of claim 1, wherein said sulfide compound is selected from the group consisting of C1-C10 dialkyl sulfide, C1-C10 dialkyl disulfide, C1-C10 dialkyl trisulfide, C1-C10 diallyl sulfide, C1-C10 diallyl disulfide, and C1-C10 diallyl trisulfide, or any combination thereof.

10. The composition of claim 1, wherein said sulfide compound is selected from the group consisting of diethyl sulfide, diethyl disulfide, dimethyl sulfide, dimethyl trisulfide, dimethyl disulfide, including any derivative or any combination thereof and wherein said alkenyl sulfide is selected from the group consisting of diallyl sulfide, diallyl disulfide (DADS), diallyl trisulfide, including any derivative or any combination thereof.

11. The composition of claim 1, further comprising an agriculturally acceptable salt and/or an agriculturally acceptable carrier, optionally wherein a w/w concentration of said agriculturally acceptable salt within said composition is between 1 and 40%; optionally wherein the agriculturally acceptable salt is selected from the group consisting of a nitrate salt, a potassium salt, and a phosphate salt including any derivative or any combination thereof, and wherein the agriculturally acceptable salt optionally comprises a microelement selected from Mg, Ca, S, Fe, Mn, Zn, B, Cu, Mo and Si, including any derivative or any combination thereof.

12. (canceled)

13. The composition of claim 1, wherein said composition further comprises an aqueous solvent, an organic water miscible solvent or both; and wherein a w/w concentration of (i) said sulfide compound, and (ii) of said surfactant within said composition is at least 0.1%.

14. (canceled)

15. (canceled)

16. (canceled)

17. (canceled)

18. (canceled)

19. The composition of claim 1, wherein a w/w concentration of (i) said sulfide compound, and (ii) of said surfactant within said composition is sufficient for inducing bud break in a plant; optionally wherein the plant is a perennial plant.

20. The composition of claim 1, wherein a w/w concentration of (i) said sulfide compound, and (ii) of said surfactant within said composition is between 0.1 and 10%; and wherein said composition is formulated for administration by spraying or by irrigating.

21. A kit comprising a first component comprising a sulfide compound and a second component comprising a surfactant; wherein said surfactant comprises an alkylated poly(ethylene glycol-co-propylene glycol) including any derivative thereof; and wherein said sulfide compound comprises an alkyl sulfide, an alkenyl sulfide, or both.

22. The kit of claim 21, wherein said alkylated poly(ethylene glycol-co-propylene glycol) (PEG-PPG) comprises any one of a linear PEG-PPG, a branched PEG-PPG, or a star-shaped PEG-PPG, substituted with a C2-C30 alkyl, wherein said C2-C30 alkyl comprises a linear or branched alkyl optionally comprising (i) at least one unsaturated bond, (ii) at least one substituent, or both (i) and (ii).

23. The kit of claim 21, wherein said alkyl sulfide is selected from the group consisting of diethyl sulfide, diethyl disulfide, dimethyl sulfide, dimethyl trisulfide, dimethyl disulfide, including any derivative or any combination thereof; and wherein said alkenyl sulfide is selected from the group consisting of diallyl sulfide, diallyl disulfide (DADS), diallyl trisulfide, including any derivative or any combination thereof.

24. The kit of claim 21, wherein said kit comprises instructions for mixing said first component and said second component, so as to obtain a mixture wherein a w/w ratio between said sulfide compound and said surfactant within said mixture is between 5:1 and 1:1.

25. (canceled)

26. A method for inducing bud break in a plant, comprising contacting said plant with the composition of claim 1.

27. The method of claim 26, wherein the plant is a perennial plant.

28. The method of claim 26, wherein said contacting comprises administering the composition or the kit to plant bulbs, plant tubers, plant roots, plant branches, plant trunk or any combination thereof; and wherein said administering is by irrigation, spraying, coating, brushing, or any combination thereof.

29. (canceled)

30. The method of claim 26, wherein a w/w concentration of said sulfide compound within said composition is between 0.1 and 10% and wherein a w/w concentration of said surfactant within said composition is between 0.01 and 10%.

31. (canceled)
